(19) United States
(12) Patent Application Publication
(10) Pub. No.: US 2025/0310009 A1
(43) Pub. Date: Oct. 2, 2025

(54) PROGRAM, CALCULATION METHOD, INFORMATION PROCESSING DEVICE, AND NON-TRANSITORY STORAGE MEDIUM

(71) Applicant: TDK Corporation, Tokyo (JP)

(72) Inventors: Masataka MIDORI, Tokyo (JP); Tomohiro HONYA, Tokyo (JP); Hiroshi KURIHARA, Tokyo (JP)

(73) Assignee: TDK Corporation, Tokyo (JP)

(21) Appl. No.: 19/088,265

(22) Filed: Mar. 24, 2025

(30) Foreign Application Priority Data
Mar. 26, 2024 (JP) 2024-049137

(51) Int. Cl. H04B 17/29

(52) U.S. Cl. CPC H04B 17/29

(57) ABSTRACT

A program causes a computer to execute a decision step of deciding a larger antenna size between antenna sizes of a transmitting antenna provided within a reverberation chamber in which a test object is arranged and a receiving antenna installed within the reverberation chamber as a target antenna size and a first calculation step of calculating a product of a value obtained by dividing a speed of light by the target antenna size decided in the decision step and a predetermined percentage of 30% or less as an interval between sampling frequencies for detecting a first frequency spectrum that is a frequency spectrum of a first transmission characteristic that is a transmission characteristic between the transmitting antenna and the receiving antenna.

### CROSS-REFERENCES TO RELATED APPLICATIONS

This application relies for priority upon Japanese Patent Application No. 2024-049137 filed on Mar. 26, 2024, the entire content of which is hereby incorporated herein by reference for all purposes as if fully set forth herein.

### BACKGROUND

The present disclosure relates to a program, a calculation method, an information processing device, and a non-transitory storage medium.

Research and development (R&D) on a radiated emission test using a reverberation chamber is being conducted. In the radiated emission test using the reverberation chamber, total radiated power radiated as electromagnetic waves from a test object is measured and the strength of an electric field generated by the electromagnetic waves radiated from the test object at a location that is a desired distance away from the test object is estimated on the basis of the measured total radiated power. The total radiated power radiated as the electromagnetic waves from the test object is measured, for example, using a substitution method. When the substitution method is used, received power output from a receiving antenna that receives the electromagnetic waves radiated from the test object within the reverberation chamber is converted into the total radiated power radiated as the electromagnetic waves from the test object according to a quantity that is a transmission characteristic.

In Patent Document 1, a method for measuring the radiation efficiency of an antenna arranged within a reverberation chamber and the communication power of a terminal provided as a test object is disclosed.

### PATENT DOCUMENTS

[Patent Document 1] Published Japanese Translation No. 2003-529983 of the PCT International Publication

### SUMMARY

When a method described in Patent Document 1 is used, a process of measuring communication power multiple times while rotating or moving a receiving antenna and a terminal provided as a test object so that the communication power is estimated and averaging values of the measured communication power may be performed. This process is laborious and time-consuming.

The present disclosure aims to provide a program, a calculation method, an information processing device, and a non-transitory storage medium storing the program for facilitating the identification of a sampling frequency at which transmission characteristics can be estimated accurately on the basis of a frequency spectrum of the transmission characteristics.

According to an aspect of the present disclosure, there is provided a program for causing a computer to execute: a decision step of deciding a larger antenna size between antenna sizes of a transmitting antenna provided within a reverberation chamber in which a test object is arranged and a receiving antenna provided within the reverberation chamber as a target antenna size; and a first calculation step of calculating a product of a value obtained by dividing a speed of light by the target antenna size decided in the decision step and a predetermined percentage of 30% or less as an interval between sampling frequencies for detecting a first frequency spectrum that is a frequency spectrum of a first transmission characteristic that is a transmission characteristic between the transmitting antenna and the receiving antenna.

Moreover, according to an aspect of the present disclosure, there is provided a calculation method including: deciding a larger antenna size between antenna sizes of a transmitting antenna provided within a reverberation chamber in which a test object is arranged and a receiving antenna provided within the reverberation chamber as a target antenna size; and calculating a product of a value obtained by dividing a speed of light by the decided target antenna size and a predetermined percentage of 30% or less as an interval between sampling frequencies for detecting a first frequency spectrum that is a frequency spectrum of a first transmission characteristic that is a transmission characteristic between the transmitting antenna and the receiving antenna.

Moreover, according to an aspect of the present disclosure, there is provided an information processing device including: a communication section communicatively connected to a transmitting antenna and a receiving antenna provided within a reverberation chamber in which a test object is arranged; and a control section configured to execute a decision process of deciding a larger antenna size between antenna sizes of a transmitting antenna and a receiving antenna as a target antenna size and a calculation process of calculating a product of a value obtained by dividing a speed of light by the target antenna size decided in the decision process and a predetermined percentage of 30% or less as an interval between sampling frequencies for detecting a first frequency spectrum that is a frequency spectrum of a first transmission characteristic that is a transmission characteristic between the transmitting antenna and the receiving antenna.

Moreover, according to an aspect of the present disclosure, there is provided a non-transitory storage medium storing the above-described program.

According to the present disclosure, it is possible to facilitate the identification of a sampling frequency at which transmission characteristics can be estimated accurately.

### BRIEF DESCRIPTION OF THE DRAWINGS

FIG. 1 is a perspective view showing an example of a configuration of an information processing device 1 according to an embodiment.

FIG. 2 is a perspective view showing an example of a configuration of a reverberation chamber 2 connected to an information processing device 1.

FIG. 3 is a perspective view showing an example of the reverberation chamber 2 with a transmitting antenna 22 in which the transmission of electromagnetic waves is stopped and a power supply of a test object TM is turned on.

FIG. 4 is a diagram showing an example of a frequency spectrum of transmission characteristics measured in a predetermined frequency band.

FIG. 5 is a diagram showing an example of a time series of the transmission characteristics obtained as a result of performing an inverse Fourier transform on the frequency spectrum shown in FIG. 4.

FIG. 6 is a diagram showing three frequency spectra, i.e., a frequency spectrum F1, a frequency spectrum F2, and a frequency spectrum F3.

FIG. 7 shows an example of a graph plotting frequency deviations of the frequency spectrum F2 and the frequency spectrum F3 from the frequency spectrum F1 shown in FIG. 6.

FIG. 8 shows an example of a graph plotting a target standard deviation of one of four frequency spectra for each different frequency interval.

FIG. 9 is a diagram of the comparison of three frequency spectra among a plurality of frequency spectra used to plot a broken line F8 shown in FIG. 8.

FIG. 10 shows an example of a graph plotting a frequency deviation of each of a frequency spectrum F2, a frequency spectrum F10, and a frequency spectrum F11 from a frequency spectrum F1 shown in FIG. 9.

FIG. 11 is a perspective view showing an example of a double-ridged guide horn antenna.

FIG. 12 is a perspective view showing an example of a log periodic antenna.

FIG. 13 is a diagram showing an example of a hardware configuration of the information processing device 1.

FIG. 14 is a diagram showing an example of a functional configuration of the information processing device 1.

FIG. 15 is a flowchart showing an example of a flow of a process in which the information processing device 1 calculates a frequency interval.

FIG. 16 is a flowchart showing an example of a flow of a process in which the information processing device 1 performs a smoothing process on a frequency spectrum detected at a sampling frequency decided on the basis of the frequency interval calculated in the process of the flowchart shown in FIG. 15.

FIG. 17 is a flowchart showing an example of a flow of a process in which the information processing device 1 performs a smoothing process on a frequency spectrum detected at a continuously varying sampling frequency.

FIG. 18 is a flowchart showing an example of a flow of a process in which the information processing device 1 calculates total radiated power radiated from a test object TM and estimates electric field strength at a desired location away from the test object TM.

### DETAILED DESCRIPTION

### <Regarding Measurement of Radiated Emission Using Reverberation Chamber>

One type of radiated emission test using a reverberation chamber is, for example, a test for confirming whether or not the electric field strength of electromagnetic waves radiated from a test object as radiated emission is equal to or less than an allowable value determined by a specific standard (for example, an international standard). The test object is a physical object on which the radiated emission test is performed. For example, the test object is an electronic device. When the test object is an electronic device, the radiated emission test is often performed before the electronic device is shipped to the market. This is because the radiated emission radiated from the electronic device may affect other electronic devices in a nearby area and, for example, may cause the other electronic devices to malfunction. In the present specification, the electric field may be read as either a magnetic field or an electromagnetic field.

The reverberation chamber includes, for example, a metallic cavity resonator, a transmitting antenna that radiates electromagnetic waves into the cavity resonator, a receiving antenna that receives the electromagnetic waves in the cavity resonator, and an electromagnetic stirrer that stirs the electromagnetic waves radiated from the transmitting antenna. Also, the reverberation chamber resonates the electromagnetic waves in the cavity resonator. The electromagnetic stirrer stirs the electromagnetic waves in the cavity resonator. In a state in which the electromagnetic waves within the cavity resonator are stirred by the electromagnetic stirrer, physical quantities such as the strength of the electric field and the received power when the electric field is received by the receiving antenna are measured, and statistics related to the measured physical quantities are calculated, a spatial distribution of the physical quantities indicated in the statistics in the cavity resonator becomes statistically uniform. Here, the statistics are statistics about a plurality of physical quantities measured at different times or a plurality of physical quantities measured in different states of the electromagnetic stirrer (for example, different angles in the case of a rotating electromagnetic stirrer). For example, a maximum value, an average value, and the like may be used as the statistics. Therefore, these statistics can also be used as physical quantities such as the strength of the electric field in the present embodiment and the received power when the electric field is received by the receiving antenna.

A procedure for the radiated emission test using the reverberation chamber is standardized, for example, as International Electrotechnical Commission (IEC) 61000-4-21 that is an IEC document. In IEC 61000-4-21, the total radiated power radiated as electromagnetic waves from a test object is measured using the substitution method. When the substitution method is used, the received power output from the receiving antenna that receives electromagnetic waves radiated from the test object within the reverberation chamber is converted into the total radiated power radiated as electromagnetic waves from the test object according to a quantity that is the transmission characteristic.

The transmission characteristic can be measured, for example, as a ratio between reference radiated power radiated as electromagnetic waves from the transmitting antenna within the reverberation chamber in a state in which the power of the test object is turned off and reference received power output from the receiving antenna that receives electromagnetic waves in the reverberation chamber in the state. In addition, these power values (i.e., the reference radiated power and the reference received power) may be replaced with other physical quantities corresponding to electromagnetic waves including a voltage and the like. Therefore, in other words, the transmission characteristic can be measured as a ratio between the input to the reverberation chamber (i.e., the electromagnetic waves radiated from the transmitting antenna as the input) and the output (i.e., the electromagnetic waves received by the receiving antenna as the output).

When the transmission characteristics are measured using the method as described above, the transmission characteristics fluctuate probabilistically. This is because the strength of the electric field of the electromagnetic waves that outputs the reference received power to the receiving antenna fluctuates probabilistically in the reverberation chamber. Although omitted for convenience of description, the statistics of the physical quantities measured in different states of the electromagnetic stirrer as described above are used as physical quantities including the received power measured by the receiving antenna of the reverberation chamber and the like in a state in which the test object is turned on so that the reference radiated power, the reference received power, the transmission characteristics, and the total radiated power of the test object are measured by the substitution method in the embodiment to be described below.

In IEC 61000-4-21, a method for reducing such fluctuations in transmission characteristics by measuring the transmission characteristics while changing the location of the receiving antenna multiple times and averaging the transmission characteristics measured multiple times is used. In other words, this is a method for obtaining highly accurate transmission characteristics by averaging the transmission characteristics measured at different locations. However, this method requires measuring the transmission characteristics multiple times, which is laborious and time-consuming.

On the other hand, in the technology according to the present disclosure described in the embodiments, it is possible to estimate the transmission characteristics with high accuracy without the labor and time required, for example, compared to when the method described in IEC 61000-4-21 is used by focusing on the frequency spectrum of the transmission characteristics. Hereinafter, the embodiment will be exemplified and the technology according to the present disclosure will be described.

### EMBODIMENTS

Hereinafter, embodiments of the present disclosure will be described with reference to the drawings. In the following description, the electric field may be read as a magnetic field or an electromagnetic field. Moreover, for convenience of description, the strength of the electric field will be simply referred to as electric field strength.

### <Configuration of Information Processing Device>

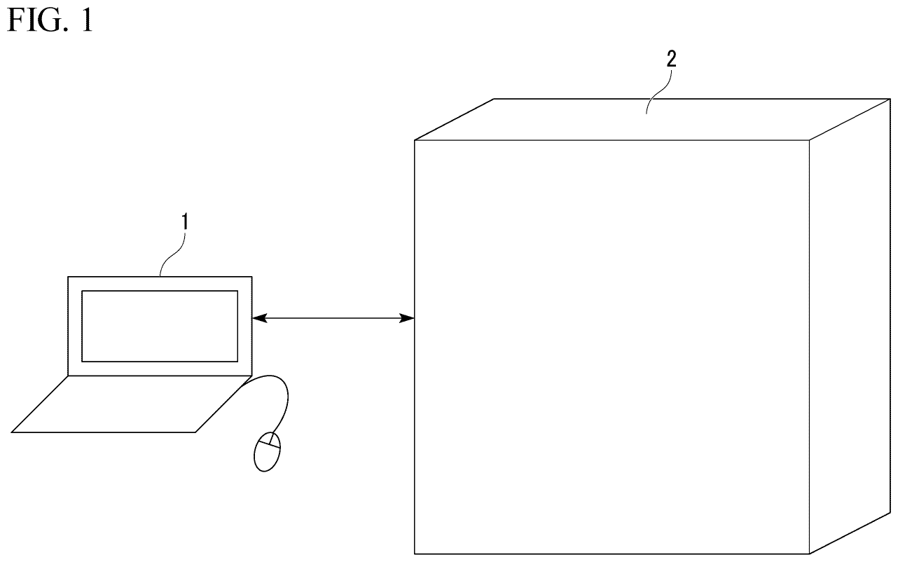

First, a configuration of an information processing device 1 according to the embodiment will be described with reference to FIG. 1. FIG. 1 is a perspective view showing an example of the configuration of the information processing device 1 according to the embodiment.

The information processing device 1 is a device that performs a radiated emission test using a reverberation chamber 2. For this reason, the information processing device 1 is communicatively connected to the reverberation chamber 2 as shown in FIG. 1. The communication between the information processing device 1 and the reverberation chamber 2 may be wired communication or wireless communication, as long as it is based on a communication standard that does not interfere with the radiated emission test. Here, the radiated emission test is a test for confirming whether or not the electric field strength of the electromagnetic waves radiated as radiated emission from the test object TM is equal to or less than an allowable value of an internationally established standard. The test object TM is a physical object on which a radiated emission test is performed. For example, the test object TM is an electronic device. When the test object TM is an electronic device, the radiated emission test is often performed before the electronic device is shipped to the market. This is because the radiated emission radiated from the electronic device may affect other electronic devices in a nearby area and, for example, cause the other electronic devices to malfunction. In addition, the electronic device on which the radiated emission test is performed as the test object TM may be any device that is electrically controlled. For this reason, the test object TM may be an electrically controlled device such as a multi-function portable phone terminal (smartphone), a portable phone terminal, a drive recorder, or various types of computers, but is not limited thereto.

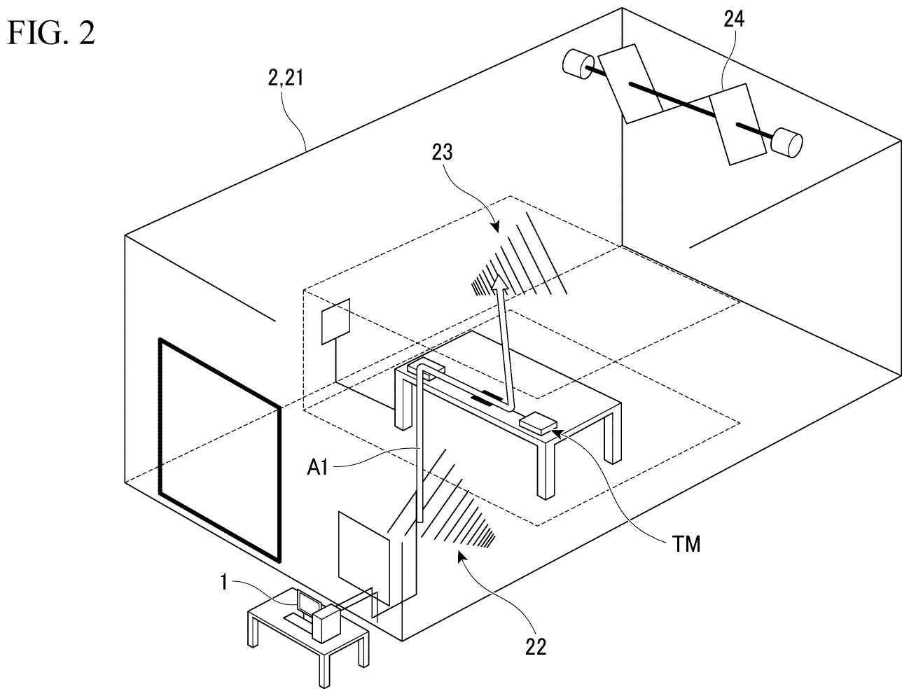

FIG. 2 is a perspective view showing an example of a configuration of the reverberation chamber 2 connected to the information processing device 1. In the example shown in FIG. 2, the reverberation chamber 2 includes a metallic cavity resonator 21, a transmitting antenna 22 that radiates electromagnetic waves into the cavity resonator 21, a receiving antenna 23 that receives the electromagnetic waves within the cavity resonator 21, and an electromagnetic stirrer 24 that stirs the electromagnetic waves radiated from the transmitting antenna 22. Also, the reverberation chamber 2 resonates the electromagnetic waves within the cavity resonator 21. Moreover, the electromagnetic stirrer 24 stirs the electromagnetic waves within the cavity resonator 21. The stirring of the electromagnetic waves by the electromagnetic stirrer 24 brings a distribution of the electric field strength in the cavity resonator 21 closer to a uniform distribution.

In the example shown in FIG. 2, each of the transmitting antenna 22, the receiving antenna 23, and the electromagnetic stirrer 24 of the reverberation chamber 2 is depicted as being communicatively connected to the information processing device 1 via a communication cable. However, this is a measure to simplify the drawing, and the actual configuration may be different therefrom. In practice, for example, the transmitting antenna 22 may be connected to the information processing device 1 via a transmitter. Thereby, the information processing device 1 controls the transmitter so that a radio frequency (RF) signal is output from the transmitter to the transmitting antenna 22 via an RF cable. The transmitting antenna 22 radiates electromagnetic waves corresponding to the RF signal output as described above. Moreover, for example, the receiving antenna 23 may be connected to the information processing device 1 via a receiver. In this case, the receiving antenna 23 outputs power corresponding to the electromagnetic waves received within the reverberation chamber 2 to the receiver via the RF cable. Also, the information processing device 1 controls the receiver and acquires electric power output to the receiver. Moreover, for example, the electromagnetic stirrer 24 may be connected to the information processing device 1 via a controller. In this case, the information processing device 1 controls the controller and causes the electromagnetic stirrer 24 to stir the electromagnetic waves within the reverberation chamber 2. In addition, some or all of the transmitter, the receiver, and the controller may be configured integrally with the information processing device 1. In the case of the configuration as described above, each of the transmitting antenna 22, the receiving antenna 23, and the electromagnetic stirrer 24 is controlled by the information processing device 1. Hereinafter, for the sake of convenience, the processes performed by the transmitter, the receiver, and the controller will be described as processes performed by the information processing device 1, and the description of the transmitter, the receiver, and the controller will be omitted. That is, the transmitting antenna 22 is configured to radiate electromagnetic waves corresponding to the RF signal input from the information processing device 1 into the reverberation chamber 2. The receiving antenna 23 is configured to output electric power corresponding to the electromagnetic waves received within the reverberation chamber 2 to the information processing device 1. The electromagnetic stirrer 24 is configured to rotate in accordance with control from the information processing device 1 and stir the electromagnetic waves within the reverberation chamber 2. In addition, in FIG. 2, communication cables connecting the receiving antenna 23 and the electromagnetic stirrer 24 to the information processing device 1 are omitted to further simplify the drawing. Moreover, in this example, the test object TM is placed on a table installed near the center of a floor surface of the cavity resonator 21.

In the radiated emission test using the reverberation chamber 2 as shown in FIG. 2, the total radiated power radiated as electromagnetic waves from the test object TM is measured and the strength of the electric field generated by the electromagnetic waves radiated from the test object TM at a location that is a desired distance away from the test object TM is measured on the basis of the measured total radiated power. A procedure for such a radiated emission test using the reverberation chamber 2 was standardized as IEC 61000-4-21 that is the IEC document in August 2003. In IEC 61000-4-21, the total radiated power radiated as electromagnetic waves by the test object is measured using the substitution method.

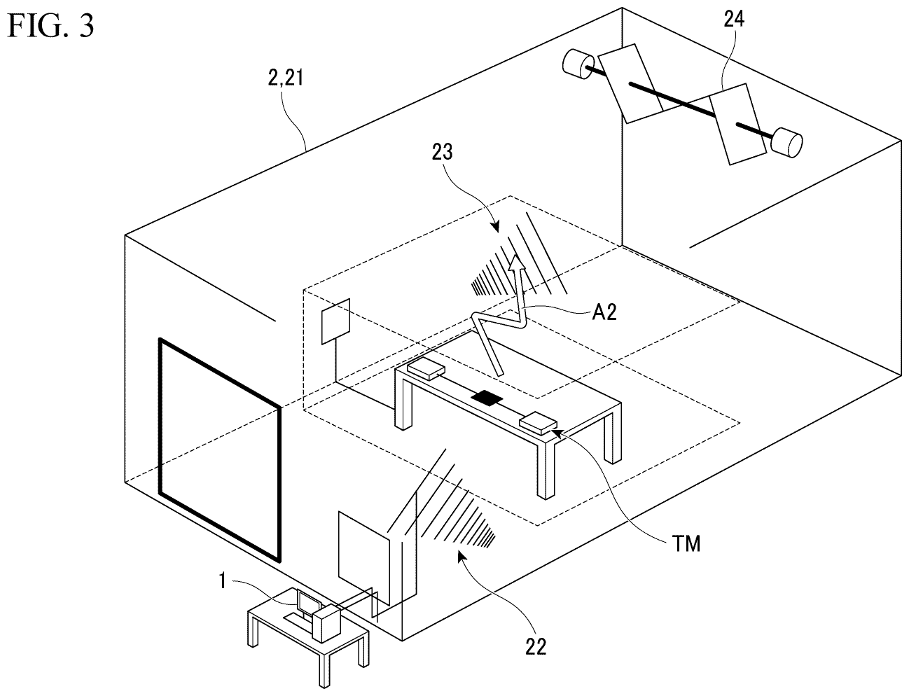

The substitution method is a method for calculating the total radiated power of the test object TM by utilizing the fact that a first power ratio and a second power ratio measured within the reverberation chamber 2 are equal. Here, the first power ratio is a ratio of a value obtained by multiplying the reference radiated power by the efficiency of the transmitting antenna 22 to the reference received power. The reference radiated power is power radiated as electromagnetic waves from the transmitting antenna 22 within the reverberation chamber 2 in a state in which the power supply of the test object TM is turned off. The reference received power is power output from the receiving antenna 23 that receives the electromagnetic waves radiated from the transmitting antenna 22 within the reverberation chamber 2 in the corresponding state. For example, in the example shown in FIG. 2, the power supply of the test object TM is turned off. Therefore, the electromagnetic waves transmitted from the transmitting antenna 22 reach the receiving antenna 23, for example, as indicated by an arrow A1 in FIG. 2. The power output from the receiving antenna 23 that receives the electromagnetic waves in this way is the reference received power. On the other hand, the second power ratio is a ratio between target received power and total radiated power radiated as electromagnetic waves from the test object TM within the reverberation chamber 2 in a state in which the radiation of the electromagnetic waves from the transmitting antenna 22 is stopped and the power supply of the test object TM is turned on. The target received power is power output from the receiving antenna 23 that receives the electromagnetic waves radiated from the test object TM within the reverberation chamber 2 in the corresponding state. Here, FIG. 3 is a perspective view showing an example of the reverberation chamber 2 in a state in which the radiation of electromagnetic waves from the transmitting antenna 22 is stopped and the power supply of the test object TM is turned on. As shown in FIG. 3, in this state, the electromagnetic waves radiated from the test object TM reach the receiving antenna 23, for example, as indicated by an arrow A2 shown in FIG. 3. In addition, hereinafter, for convenience of description, the reference received power and the target received power will be collectively referred to as the received power unless there is a need to distinguish between the reference received power and the target received power.

The fact that the first power ratio and the second power ratio measured within the reverberation chamber 2 are equal is expressed by the following Eq. (1). Here, tx denotes efficiency of the transmitting antenna. Pᵢₙₚᵤₜ denotes reference radiated power. P_{EUT} denotes total radiated power radiated as electromagnetic waves from the test object TM. Pmeas denotes target received power.

$${η}_{tx} {P}_{input} : {P}_{ref} = {P}_{EUT} : {P}_{meas} \qquad ( 1 )$$

Here, when the above Eq. (1) is solved for P_{EUT}, Eq. (1) can be transformed into the following Eq. (2).

$${P}_{EUT} = \frac{{P}_{meas} \times {η}_{tx}}{\frac{{P}_{ref}}{{P}_{input}}} \qquad ( 2 )$$

(P_{ref}/Pᵢₙₚᵤₜ) in the above Eq. (2) denotes a quantity that is the transmission characteristic. In other words, the total radiated power of the test object TM can be calculated by measuring the target received power and the transmission characteristic. The method for calculating the total radiated power radiated as electromagnetic waves from the test object TM in this way is the substitution method.

When the total radiated power radiated as electromagnetic waves from the test object TM is calculated by the substitution method, the electric field strength at a location that is a desired distance away from the test object TM can be calculated on the basis of the following Eq. (3). Here, E_{Radiated} denotes strength of the electric field generated by the electromagnetic waves radiated from the test object TM at a location that is a distance R away from the test object TM. D denotes maximum directivity of the test object TM and a value that is usually estimated in advance is used. R denotes a distance from the test object TM. η₀ denotes characteristic impedance of free space, which is 377Ω.

$${E}_{Radiated} = \sqrt{\frac{D \times {P}_{EUT} \times {η}_{0}}{4 π {R}^{2}}} \qquad ( 3 )$$

Here, as described above, the electromagnetic waves are stirred by the electromagnetic stirrer within the reverberation chamber 2. Therefore, many multipath waves with different phases are generated within the reverberation chamber 2 due to the rotation of the electromagnetic stirrer 24. As a result, real and imaginary terms of orthogonal components of the electric field in the reverberation chamber 2 approach a normal distribution due to the central limit theorem. There is no correlation between these real and imaginary terms. Therefore, these real and imaginary terms are independent probability variables. It is known that when a probability density function for the electric field strength received by the receiving antenna 23 within the reverberation chamber 2 is calculated from these real and imaginary terms, the distribution follows a Rayleigh distribution. Because the electric field strength received by the receiving antenna 23 within the reverberation chamber 2 is obtained as a probability variable following a Rayleigh distribution, the received power output from the receiving antenna 23 is also obtained as a probability variable.

On the other hand, it is also known that the above-described transmission characteristic can be calculated on the basis of the following Eq. (4). Here, Q denotes a Q value of the reverberation chamber 2. ηrx denotes efficiency of the receiving antenna. A denotes a wavelength of the electromagnetic waves received by the receiving antenna 23. V denotes a volume of the reverberation chamber 2. c denotes a speed of light. t denotes a time constant of the reverberation chamber 2.

$$Transmission Characteristic = ( \frac{{η}_{tx} {η}_{rx} {λ}^{3}}{16 {π}^{2} V} ) Q = ( \frac{{η}_{tx} {η}_{rx} c {λ}^{2}}{8 π V} ) τ \qquad ( 4 )$$

From Eq. (4), it can be seen that there is no element of probability variables because the transmission characteristics are calculated from unique values determined by the reverberation chamber 2, the transmitting antenna 22, the receiving antenna 23, and the like. In contrast, when the transmission characteristics are calculated using (P_{ref}/Pᵢₙₚᵤₜ) in Eq. (2), the transmission characteristics fluctuate probabilistically. This is because the electric field strength of the electromagnetic waves for outputting the reference received power to the receiving antenna 23 fluctuates probabilistically inside the reverberation chamber 2.

As described above, when the method described in IEC 61000-4-21 is adopted, for example, a process is executed to reduce the fluctuations in the transmission characteristics by measuring the transmission characteristics while changing the location of the receiving antenna 23 multiple times and averaging the transmission characteristics measured multiple times so that such fluctuations in the transmission characteristics are reduced. However, as described above, this method has the drawback of requiring multiple measurements of transmission characteristics, making it both laborious and time-consuming.

Therefore, the information processing device 1 calculates an interval between sampling frequencies in the frequency spectrum of the transmission characteristics between the transmitting antenna 22 and the receiving antenna 23 installed within the reverberation chamber 2 where the test object TM is arranged. Specifically, the information processing device 1 receives a larger antenna size between the antenna sizes of the transmitting antenna 22 and the receiving antenna 23 as a target antenna size and calculates a product of a value obtained by dividing the speed of light by the received target antenna size and a predetermined percentage of 30% or less as the interval. Thereby, the information processing device 1 can easily identify a sampling frequency for enabling the fluctuation in the transmission characteristics to be accurately reduced in a process of averaging the transmission characteristics between different sampling frequencies. The reason for this will be described below. In the present embodiment, the process of calculating the interval among the processes performed by the information processing device 1 will be described in detail. In addition, hereinafter, for convenience of description, the interval will be referred to as a frequency interval.

The information processing device 1 may be, for example, a notebook personal computer (PC), a desktop PC, a workstation, a tablet PC, a multi-function portable phone terminal (smartphone), a portable phone terminal, a personal digital assistant (PDA), or the like, but is not limited thereto. In FIG. 1, the information processing device 1 is depicted as a notebook PC. On the other hand, in FIG. 2 and FIG. 3, the information processing device 1 is depicted as a desktop PC.

<Principle by which the Information Processing Device Calculates Frequency Interval>

A principle by which the information processing device 1 calculates a frequency interval will be described below.

First, the cause of the fluctuation in the transmission characteristics is considered. As described above, the transmission characteristics can be calculated by Eq. (4). In Eq. (4), V, which denotes the volume of the reverberation chamber 2, c, which denotes the speed of light, and t, which denotes a time constant inside the reverberation chamber 2, do not have frequency characteristics. Moreover, in Eq. (4), A, which denotes a wavelength of the electromagnetic waves received by the receiving antenna 23, is proportional to a frequency, but can be treated as having no frequency characteristic approximately by approximation such as logarithmic approximation. On the other hand, in Eq. (4), ηₜₓ, which denotes efficiency of the transmitting antenna 22, and ηᵣₓ, which denotes efficiency of the receiving antenna 23, each have a frequency characteristic. This suggests that the frequency characteristic in the transmission characteristics is a characteristic caused by each of the transmitting antenna 22 and the receiving antenna 23.

Therefore, if a fluctuation unrelated to each of the transmitting antenna 22 and the receiving antenna 23 among the fluctuations of the transmission characteristic can be equalized according to a smoothing process from the frequency spectrum of the transmission characteristic, it is considered that the fluctuation of the transmission characteristic can be reduced.

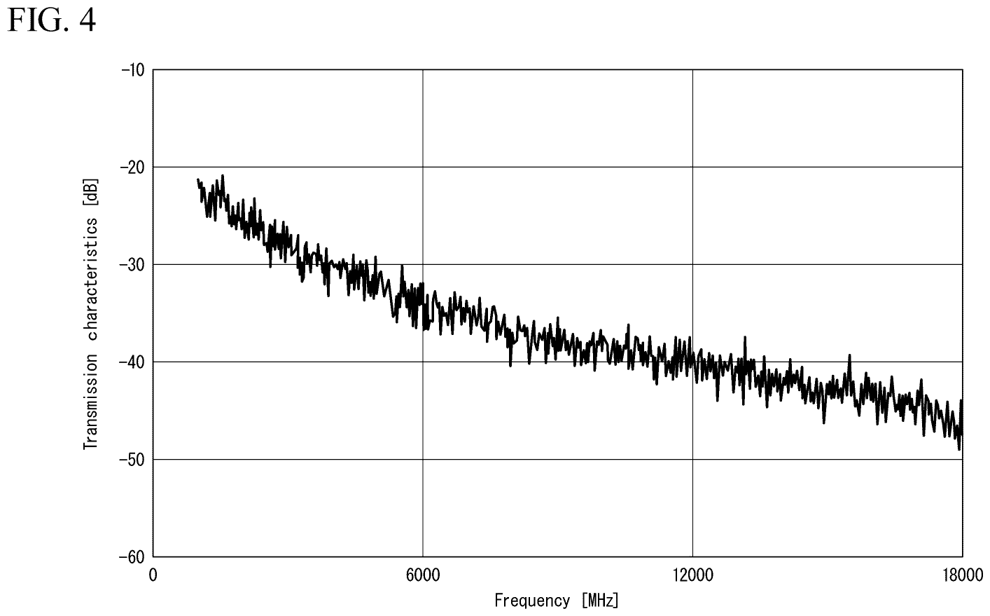

Here, FIG. 4 is a diagram showing an example of the frequency spectrum of the transmission characteristic measured in a predetermined frequency band. The frequency band may be any frequency band as long as it includes the frequency band of the electromagnetic waves radiated from the test object TM. The horizontal axis of the graph shown in FIG. 4 represents a frequency. Moreover, the vertical axis of the graph represents the transmission characteristic indicated by the deviation. As shown in FIG. 4, the measured transmission characteristic has a frequency characteristic, reflecting that the electric field received by the receiving antenna 23 has a frequency characteristic. Moreover, as described above, the measured transmission characteristic fluctuates, reflecting that the electric field strength within the reverberation chamber 2 fluctuates probabilistically.

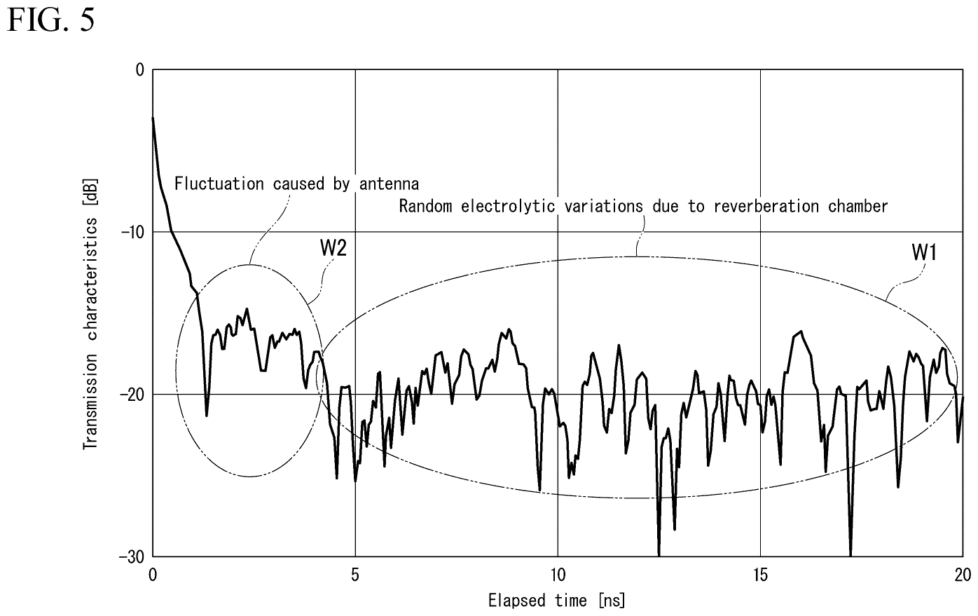

On the other hand, FIG. 5 shows an example of a time series of the transmission characteristic obtained as a result of performing an inverse Fourier transform on the frequency spectrum shown in FIG. 4. The horizontal axis of the graph shown in FIG. 5 represents an elapsed time from the origin, which is the time when the measurement of the frequency spectrum was started. The vertical axis of the graph represents a transmission characteristic indicated by the deviation like the vertical axis of the graph shown in FIG. 4. In the example shown in FIG. 5, the fluctuations of the transmission characteristics in the time period after 5 ns, i.e., in the time period of the area surrounded by a circle W1 shown in FIG. 5, are random. For this reason, it is estimated that the fluctuation is caused by the electric field fluctuation due to the reverberation chamber 2. On the other hand, the fluctuations in the transmission characteristics during the time of the area period surrounded by a circle W2 shown in FIG. 5 are not random.

Here, FIGS. 4 and 5 are graphs obtained as results of using double-ridged guide horn antennas as the transmitting antenna 22 and the receiving antenna 23. When the time period of the area surrounded by the circle W2 is converted into a distance using the speed of light, it is twice a distance from the power supply to an opening of the double-ridged guide horn antenna, i.e., it coincides with a reflected light path. This may suggest that the fluctuations in the transmission characteristics during the time period of the area surrounded by the circle W2 are caused by each of the transmitting antenna 22 and the receiving antenna 23. In other words, when the structures of the transmitting antenna 22 and the receiving antenna 23 are taken into account, it is conceivable that the fluctuations in the transmission characteristics during the time period of the area surrounded by the circle W2 are caused by the reflection of electromagnetic waves generated by discontinuity between an element radiating the electromagnetic waves and a space around that element.

From the above, it can be considered that smoothing the time series of transmission characteristics during a time period when the transmission characteristics are randomly fluctuating corresponds to smoothing the fluctuations of the transmission characteristics that are unrelated to the transmitting antenna 22 and the receiving antenna 23. Also, smoothing the time series of transmission characteristics during a time period when the transmission characteristics are randomly fluctuating can be achieved by a smoothing process such as a moving average process or a time gate process (which may also be referred to as time gating). Hereinafter, for the sake of convenience, the time series of transmission characteristics during a time period when the transmission characteristics are randomly fluctuating will be referred to as a time series to be smoothed.

In addition, the time period when the transmission characteristics are not randomly fluctuating varies with a larger antenna size between the antenna sizes of the transmitting antenna 22 and the receiving antenna 23. This can also be inferred from the fact that the time period in the example shown in FIG. 5 is twice the distance from the power supply to the opening of the double-ridged guide horn antenna, i.e., coincides with the reflected light path. Moreover, it is conceivable that a frequency spectrum of the transmission characteristics can be acquired with high accuracy by measuring the transmission characteristics at least during the time period. This is because it corresponds to the acquisition of response characteristics of the fluctuation of the transmission characteristics due to the antenna. Also, the measurement time on the time axis shown in FIG. 5 corresponds to the above-described frequency interval. This means that it is possible to detect a frequency spectrum including at least the response characteristics of the fluctuation of the transmission characteristics due to the antenna by determining the frequency interval in accordance with a larger antenna size between the antenna sizes of the transmitting antenna 22 and the receiving antenna 23.

Here, it is not easy to theoretically determine a frequency interval in accordance with a larger antenna size between the antenna sizes of the transmitting antenna 22 and the receiving antenna 23 so that at least the frequency spectrum including the response characteristics of the fluctuation of the transmission characteristics due to the antenna is measured accurately. For this reason, the method for determining the frequency interval according to the antenna size, for example, may be determined experimentally. Therefore, the method for experimentally determining the frequency interval will be described below. In addition, for convenience of description, the larger antenna size between the antenna sizes of the transmitting antenna 22 and the receiving antenna 23 will be referred to as the target antenna size in the following description. The target antenna size will be described below.

Three frequency spectra, namely, a frequency spectrum F1, a frequency spectrum F2, and a frequency spectrum F3, are compared so that a method for determining the frequency interval according to the target antenna size is experimentally identified.

The frequency spectrum F1 is a frequency spectrum to be compared with the frequency spectrum F2 and the frequency spectrum F3, which have different frequency intervals. In other words, the frequency spectrum F1 is a reference frequency spectrum as a frequency spectrum of the transmission characteristics. Specifically, the frequency spectrum F1 is a frequency spectrum of the transmission characteristics obtained by measuring the transmission characteristics while changing the location of the receiving antenna 23 multiple times and averaging the transmission characteristics measured multiple times. Therefore, the frequency spectrum F1 is a frequency spectrum obtained by a conventional method as the frequency spectrum of the transmission characteristics.

For this reason, the frequency spectrum F1 is detected while the frequency in a predetermined frequency band FR continuously varies. The frequency band FR may be any frequency band as long as it includes the frequency of the electromagnetic waves radiated from the test object TM.

On the other hand, the frequency spectrum F2 is a frequency spectrum of the transmission characteristics measured without changing the location of the receiving antenna 23. The frequency spectrum F2 is detected while the frequency discretely changes so that the frequency interval is 21.25 MHz in the predetermined frequency band FR. In other words, the frequency interval of the frequency spectrum F2 is 21.25 MHz.

Moreover, the frequency spectrum F2 is smoothed by a moving average process. This moving average process is a process of performing a moving average for each of the three sampling frequencies arranged in ascending order. Detecting the frequency spectrum while discretely changing the frequency in this way and performing the moving average process is equivalent to smoothing components of the time series to be smoothed in the frequency spectrum F2 in a smoothing process. The number of sampling frequencies used in the moving average process may be two or may be four or more.

Moreover, the frequency spectrum F3 is a frequency spectrum of the transmission characteristics measured without changing the location of the receiving antenna 23. The frequency spectrum F3 is detected while the frequency discretely changes so that the frequency interval is 1360 MHz in the predetermined frequency band FR. That is, the frequency interval of the frequency spectrum F3 is 1360 MHz. Moreover, the frequency spectrum F3 is smoothed by a moving average process similar to that on the frequency spectrum F2. Detecting the frequency spectrum while discretely changing the frequency in this way and performing the moving average process is equivalent to smoothing components of the time series to be smoothed in the frequency spectrum F3 in a smoothing process.

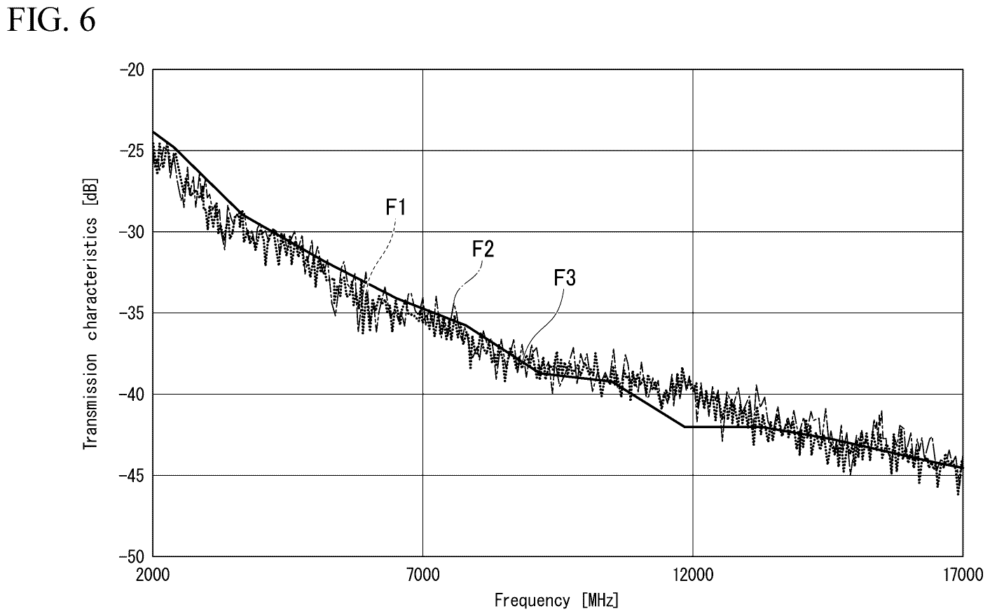

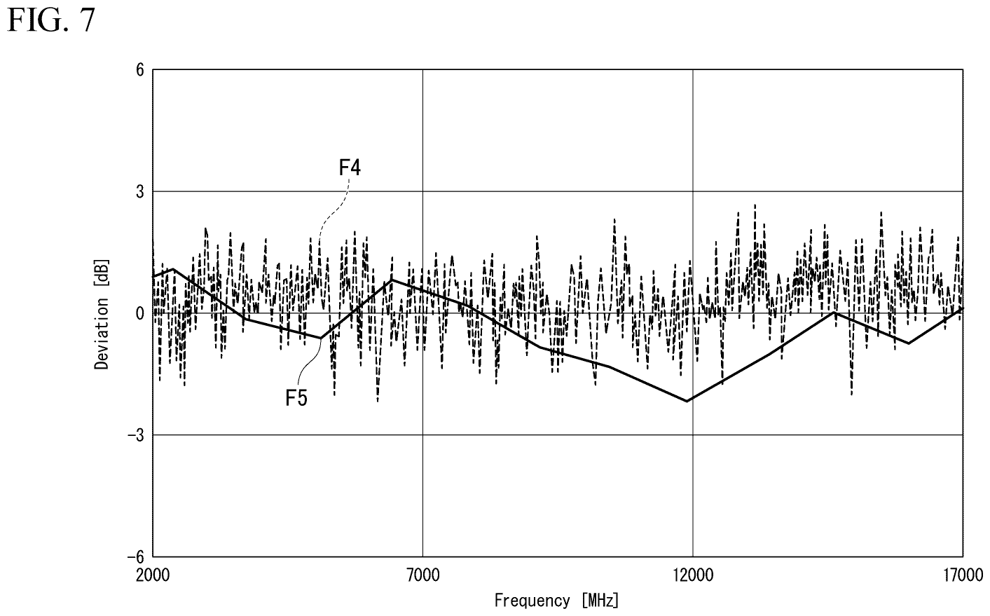

FIG. 6 is a diagram showing an example of three frequency spectra, namely, a frequency spectrum F1, a frequency spectrum F2, and a frequency spectrum F3. The horizontal axis of the graph shown in FIG. 6 represents a frequency. The vertical axis of the graph represents transmission characteristics. As shown in FIG. 6, the frequency spectrum F2 fluctuates to the same extent as the frequency spectrum F1. This means that when the frequency interval is 21.25 MHz, the frequency average of the transmission characteristics can be detected with approximately the same detection accuracy as the transmission characteristics according to the conventional method. On the other hand, as shown in FIG. 6, the frequency spectrum F3 fluctuates to approximately the same extent as the frequency spectrum F1 in some ranges, but has greater fluctuation than the frequency spectrum F1 in other ranges. In the example shown in FIG. 6, the frequency spectrum F3 deviates significantly from the frequency spectrum F1 in the vicinity of 12000 MHz. These can be understood more clearly by looking at FIG. 7. FIG. 7 shows an example of a graph plotting frequency deviations of the frequency spectrum F2 and the frequency spectrum F3 from the frequency spectrum F1 shown in FIG. 6. The horizontal axis of the graph represents a frequency. The vertical axis of the graph represents the deviation. A broken line F4 shown in FIG. 7 indicates a deviation at each frequency of the frequency spectrum F2 for the frequency spectrum F1. A broken line F5 shown in FIG. 7 indicates a frequency deviation of the frequency spectrum F3 from the frequency spectrum F1.

The graphs shown in FIGS. 6 and 7 show that the detection accuracy of the transmission characteristics obtained by performing the moving average process is approximately the same as the detection accuracy of the transmission characteristics obtained by the conventional method as the frequency interval decreases and that the detection accuracy of the transmission characteristics obtained by performing the moving average process becomes lower than the detection accuracy of the transmission characteristics obtained by the conventional method as the frequency interval excessively increases. Therefore, it is considered appropriate to adjust the frequency interval within a certain upper limit range without increasing it indefinitely so that the detection accuracy of the transmission characteristics obtained by performing the moving average process is maintained at the same level as the detection accuracy of the transmission characteristics obtained by the conventional method.

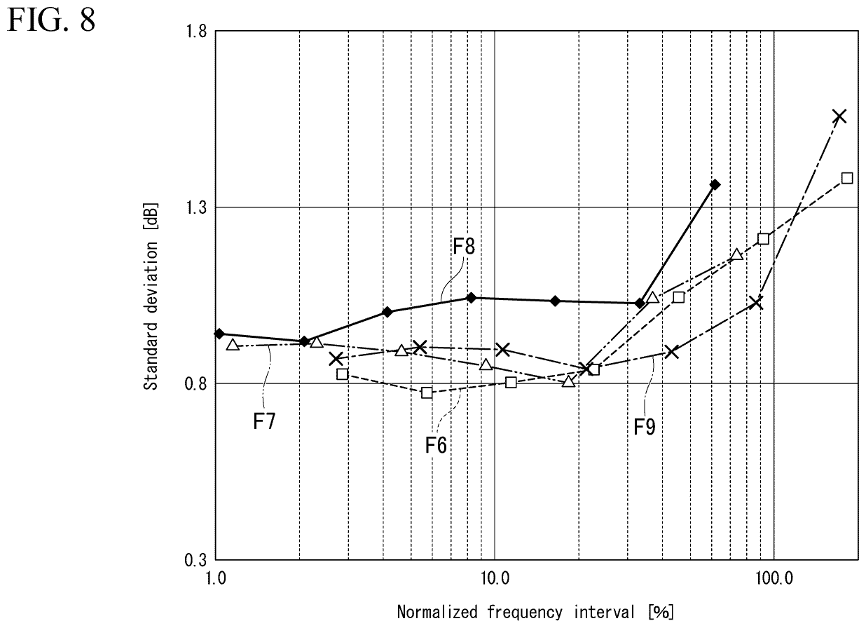

Therefore, a process is considered to identify the upper limit of the frequency interval for enabling the detection accuracy of the transmission characteristics obtained by performing the moving average process to be maintained at approximately the same level as the detection accuracy of the transmission characteristics obtained by the conventional method. It is considered that, when a standard deviation indicating a variation in deviation shown in FIG. 7 is plotted for each different frequency interval, it is possible to obtain the upper limit of the frequency interval at which a frequency spectrum with a highly accurate transmission characteristic can be detected. Hereinafter, for convenience of description, the standard deviation indicating the variation in deviation between a certain frequency spectrum and the frequency spectrum F1 is referred to as a target standard deviation of the frequency spectrum. FIG. 8 shows an example of a graph in which the target standard deviation of each of four frequency spectra is plotted for each different frequency interval. The horizontal axis of the graph shown in FIG. 8 represents a normalized frequency interval. Here, a normalized frequency interval is a ratio of the frequency interval to the value obtained by dividing the speed of light by the target antenna size. The normalized frequency interval is used in the graph because the frequency interval is determined in accordance with the target antenna size and it is easier to use when normalized by the target antenna size. The vertical axis of the graph represents a standard deviation. Here, the frequency spectra corresponding to the four target standard deviations plotted on the graph are associated with different antenna combinations. Specifically, the frequency spectrum corresponding to each of the four target standard deviations plotted on the graph is associated with any one of a combination of antennas A, a combination of antennas B, a combination of antennas C, and a combination of antennas D.

The combination of antennas A is a combination of double-ridged guide horn antennas with a frequency range of 1 GHz to 18 GHz. That is, a frequency spectrum associated with the combination of antennas A is a frequency spectrum detected using the double-ridged guide horn antenna as each of the transmitting antenna 22 and the receiving antenna 23. Also, a broken line F6 shown in FIG. 8 is a broken line plotting the target standard deviation of the frequency spectrum associated with the combination of antennas A at each different normalized frequency interval.

The combination of antennas B is also a combination of double-ridged guide horn antennas with a frequency range of 1 GHz to 18 GHz. However, the double-ridged guide horn antenna in the combination of antennas B has a different model number from the double-ridged guide horn antenna in the combination of antennas A. The frequency spectrum associated with the combination of antennas B is a frequency spectrum detected using a double-ridged guide horn antenna in the combination of antennas B as the transmitting antenna 22 and the receiving antenna 23. Also, a broken line F7 shown in FIG. 8 is a broken line plotting the target standard deviation of the frequency spectrum associated with the combination of antennas B for each different normalized frequency interval.

The combination of antennas C is a combination of double-ridged guide horn antennas with a frequency range of 2 GHz to 18 GHz. That is, the frequency spectrum associated with the combination of antennas C is a frequency spectrum detected using the double-ridged guide horn antenna as each of the transmitting antenna 22 and the receiving antenna 23. Also, a broken line F8 shown in FIG. 8 is a broken line plotting the target standard deviation of the frequency spectrum associated with the combination of antennas C for each different normalized frequency interval.

The combination of antennas D is a combination of log periodic antennas with a frequency range of 1 GHz to 18 GHz. That is, the frequency spectrum associated with the combination of antennas D is a frequency spectrum detected using the log periodic antenna as each of the transmitting antenna 22 and the receiving antenna 23. Also, a broken line F9 shown in FIG. 8 is a broken line plotting the target standard deviation of the frequency spectrum associated with the combination of antennas D for each different normalized frequency interval.

As shown in FIG. 8, each of the broken lines F6 to F9 converges to an approximately constant value when the normalized frequency interval is 30% or less. From this, it is inferred that the target standard deviation increases when the normalized frequency interval exceeds 30%, regardless of the type of antenna used as the transmitting antenna 22 and the receiving antenna 23. From this, it is possible to experimentally obtain that the upper limit of the frequency interval for enabling the detection accuracy of the transmission characteristics to be maintained at the same level as the detection accuracy of the transmission characteristics by the conventional method is, for example, the frequency interval when the normalized frequency interval is 30%. In other words, the frequency interval for enabling the detection accuracy of the transmission characteristics obtained by performing the moving average process to be maintained at the same level as the detection accuracy of the transmission characteristics obtained by the conventional method can be calculated as a product of a value obtained by dividing the target antenna size by the speed of light and a predetermined percentage of 30% or less. That is, an operator who performs a radiated emission test using the reverberation chamber 2 selects a value of 30% or less as the normalized frequency interval and calculates a product of the selected value and the value obtained by dividing the target antenna size by the speed of light, thereby obtaining a frequency interval for enabling the detection accuracy of the transmission characteristics obtained by performing the moving average process to be maintained at the same level as the detection accuracy of the transmission characteristics obtained by the conventional method. For this reason, the information processing device 1 receives the target antenna size, and calculates a product of a value obtained by dividing the speed of light by the received target antenna size and a predetermined rate of 30% or less as the frequency interval. Thereby, the information processing device 1 can easily identify a sampling frequency for enabling the fluctuation in the transmission characteristics to be accurately reduced in a process of averaging the transmission characteristics between different sampling frequencies.

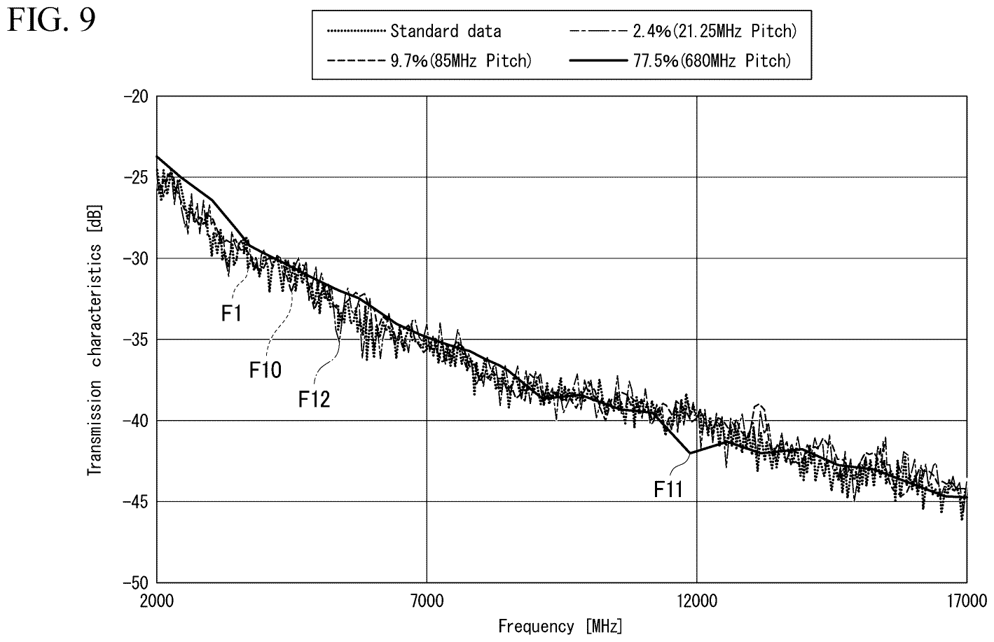

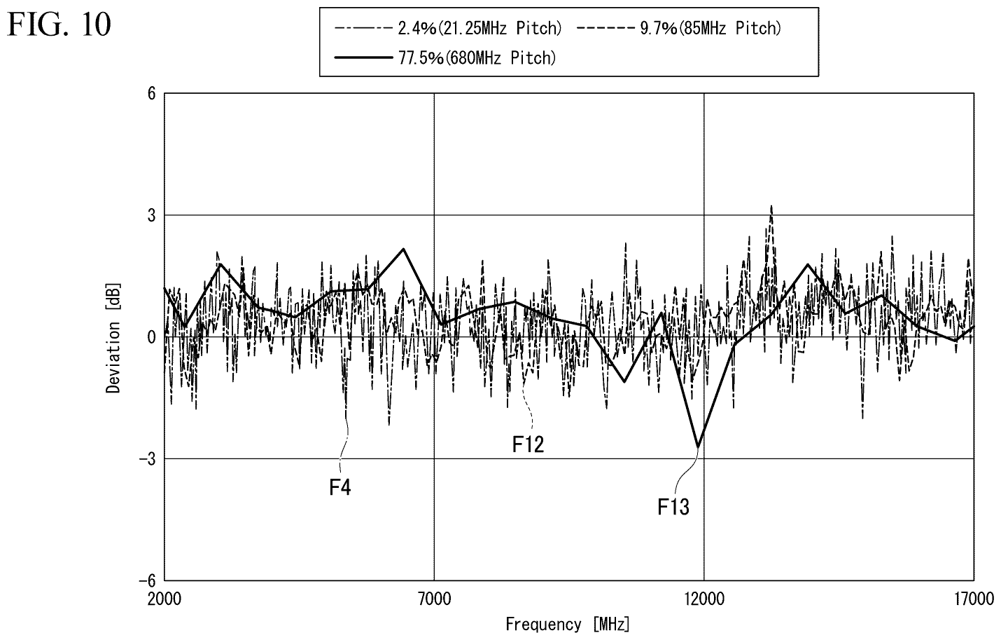

In addition, an example of a corresponding relationship between the normalized frequency interval and the frequency interval will be described with reference to FIGS. 9 and 10. FIG. 9 is a diagram of the comparison of three frequency spectra among a plurality of frequency spectra used to plot the broken line F7 shown in FIG. 8. The horizontal axis of the graph shown in FIG. 9 represents a frequency. The vertical axis of the graph represents a transmission characteristic indicated by the deviation. However, the above-described frequency spectrum F1 as a comparison target is also plotted on the graph. One of the three frequency spectra is the above-described frequency spectrum F2. As described above, the frequency interval of the frequency spectrum F2 is 21.25 MHz. In this case, the normalized frequency spectrum is 2.4%. Among the three frequency spectra, the frequency spectrum F10 is a frequency spectrum of the transmission characteristics measured without changing the location of the receiving antenna 23. The frequency spectrum F10 is detected while the frequency discretely changes so that the frequency interval is 85 MHz in the predetermined frequency band FR. In other words, the frequency interval of the frequency spectrum F10 is 85 MHz. In this case, the normalized frequency spectrum is 9.7%. Moreover, the frequency spectrum F10 is smoothed in a moving average process similar to that on the frequency spectrum F2. Among the three frequency spectra, the frequency spectrum F11 is a frequency spectrum of the transmission characteristics measured without changing the location of the receiving antenna 23. The frequency spectrum F11 is detected while the frequency discretely changes so that the frequency interval is 680 MHz in the predetermined frequency band FR. That is, the frequency interval of the frequency spectrum F11 is 680 MHz. In this case, the normalized frequency spectrum is 77.5%. Moreover, the frequency spectrum F11 is smoothed in a moving average process similar to that on the frequency spectrum F2.

Moreover, FIG. 10 shows an example of a graph plotting a frequency deviation of each of the frequency spectrum F2, the frequency spectrum F10, and the frequency spectrum F11 from the frequency spectrum F1 shown in FIG. 9. The horizontal axis of the graph represents a frequency. The vertical axis of the graph represents a deviation. A broken line F4 shown in FIG. 10 is similar to the broken line F4 shown in FIG. 6. On the other hand, a broken line F12 indicates each frequency deviation of the frequency spectrum F10 from the frequency spectrum F1. A broken line F13 indicates each frequency deviation of the frequency spectrum F11 from the frequency spectrum F1.

As shown in FIGS. 9 and 10, when the normalized frequency interval is 30% or less, the detection accuracy of the transmission characteristics obtained by performing the moving average process becomes approximately the same as the detection accuracy of the transmission characteristics obtained by the conventional method as the frequency interval becomes smaller. This is a result that does not contradict the result in FIG. 8. On the other hand, when the normalized frequency interval is more than 30%, the detection accuracy of the transmission characteristics obtained by performing the moving average process becomes lower than the detection accuracy of the transmission characteristics obtained by the conventional method. This is also a result that does not contradict the result in FIG. 8.

The above results were obtained using the frequency spectrum of the transmission characteristics detected when the type of antenna used as the transmitting antenna 22 was the same as the type of antenna used as the receiving antenna 23. It is estimated that the above results will not change even if the type of antenna used as the transmitting antenna 22 is different from the type of antenna used as the receiving antenna 23. This is because the frequency interval is determined in accordance with a larger antenna size between the antenna sizes of the transmitting antenna 22 and the receiving antenna 23, i.e., the target antenna size.

### <Antenna Size Calculation Method>

Hereinafter, an antenna size calculation method will be described. In addition, hereinafter, as an example, a method for calculating an antenna size for each of a double-ridged guide horn antenna and a log periodic antenna will be described as the antenna size calculation method.

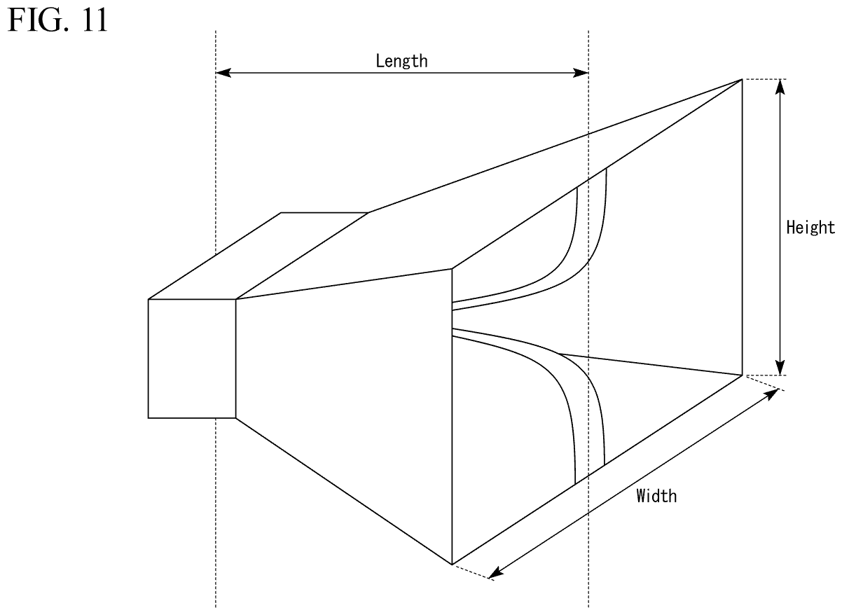

FIG. 11 is a perspective view an example of a double-ridged guide horn antenna. As shown in FIG. 11, three dimensions, i.e., Length, which is a length from a power supply section to an opening of the double-ridged guide horn antenna, Width, which is a length in the long direction of the opening, and Height, which is a length in the short direction of the opening, can be defined for the double-ridged guide horn antenna. In this case, the antenna size of the double-ridged guide horn antenna is calculated, for example, as the square root of the sum of the squares of Length, Width, and Height. In other words, an antenna size of the double-ridged guide horn antenna is calculated by √(Length²+Width²+Height²). In addition, the antenna size of the double-ridged guide horn antenna may be another value corresponding to a dimension of the double-ridged guide horn antenna.

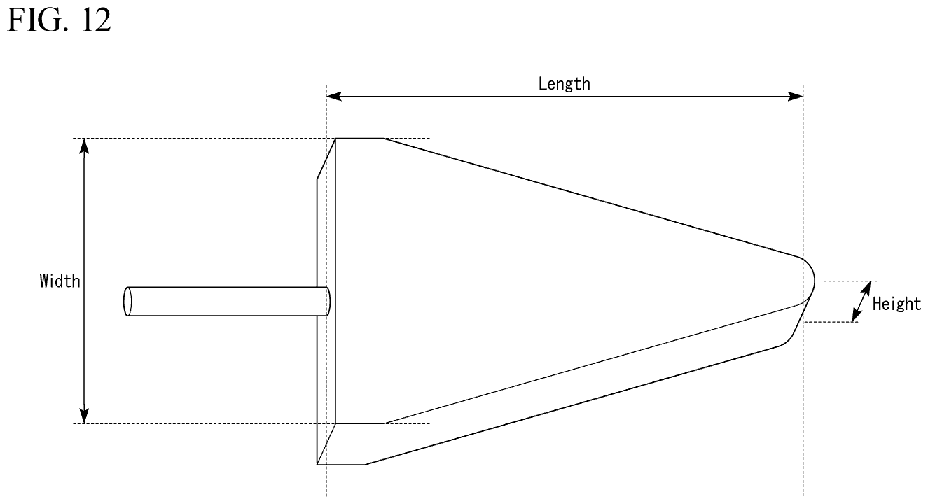

FIG. 12 is a perspective view showing an example of a log periodic antenna. As shown in FIG. 12, three dimensions, i.e., Length, which is a length from a power supply section to a tip of the log periodic antenna, Width, which is a length in the long direction of the power supply section, and Height, which is a length in the short direction of the power supply section, can be defined for the log periodic antenna. In this case, an antenna size of the log periodic antenna is calculated, for example, as the square root of the sum of the squares of Length, Width, and Height. In other words, the antenna size of the log periodic antenna is calculated by √(Length²+Width²+Height²). In addition, the antenna size of the log periodic antenna may be another value according to a dimension of the log periodic antenna.

### <Hardware Configuration of Information Processing Device>

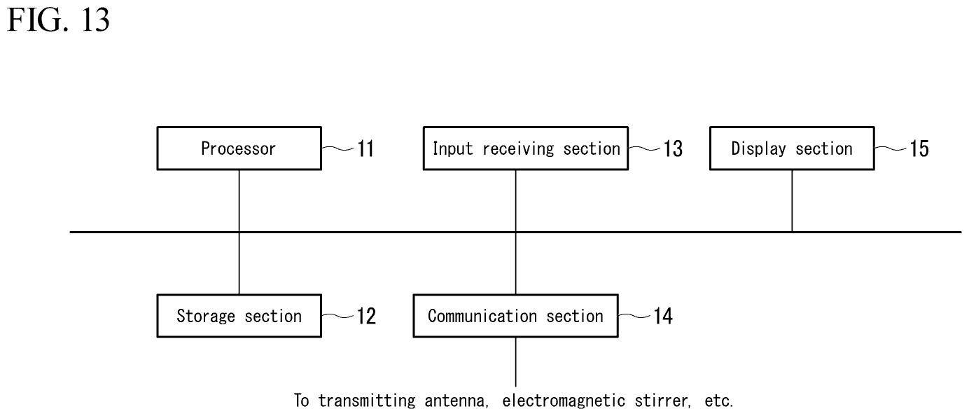

Hereinafter, a hardware configuration of the information processing device 1 will be described with reference to FIG. 13. FIG. 13 is a diagram showing an example of the hardware configuration of the information processing device 1.

The information processing device 1 includes, for example, a processor 11, a storage section 12, an input receiving section 13, a communication section 14, and a display section 15. These constituent elements are communicatively connected to each other via a bus. The information processing device 1 also communicates with the reverberation chamber 2 and the like via the communication section 14.

The processor 11 is, for example, a central processing unit (CPU). In addition, the processor 11 may be another processor such as a field programmable gate array (FPGA) instead of the CPU. The processor 11 executes various types of programs stored in the storage section 12.

The storage section 12 is, for example, a storage device including a hard disk drive (HDD), a solid-state drive (SSD), an electrically erasable programmable read-only memory (EEPROM), a read-only memory (ROM), a random-access memory (RAM), and the like. The storage section 12 may be an external storage device connected via a digital input/output port such as a universal serial bus (USB) instead of being built into the information processing device 1. The storage section 12 stores various types of information, various types of images, and various types of programs processed by the information processing device 1. In other words, various types of information stored by the information processing device 1 is stored in the storage section 12.

The input receiving section 13 is an input device such as a keyboard, a mouse, or a touchpad. The input receiving section 13 may be integrated with the display section 15 as a touch panel.

The communication section 14 is a communication device including, for example, a digital input/output port such as a USB, an Ethernet (registered trademark) port, an antenna for wireless communication, and the like.

The display section 15 is a display device including a liquid crystal display or the like. In addition, the communication section 14 and the display section 15 may be read as output sections capable of providing (or displaying) some data to the outside of the information processing device 1.

### <Functional Configuration of Information Processing Device>

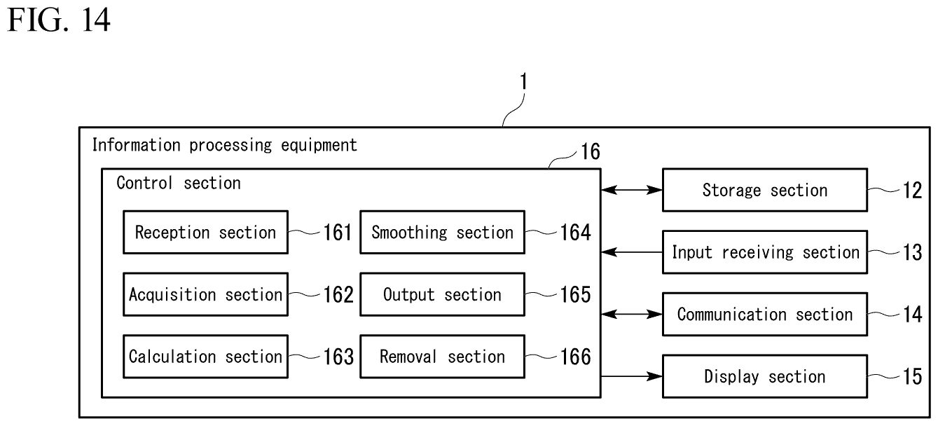

A functional configuration of the information processing device 1 will be described below with reference to FIG. 14. FIG. 14 is a diagram showing an example of a functional configuration of the information processing device 1.

The information processing device 1 includes a storage section 12, an input receiving section 13, a communication section 14, a display section 15, and a control section 16.

The control section 16 controls the entire information processing device 1. The control section 16 includes a reception section 161, an acquisition section 162, a calculation section 163, a smoothing section 164, an output section 165, and a removal section 166. These functional sections provided in the control section 16 are implemented, for example, by the processor 11 executing various types of programs stored in the storage section 12. Moreover, some or all of the functional sections may be hardware functional sections such as a large-scale integration (LSI) circuit and an application-specific integrated circuit (ASIC).

The reception section 161 receives various types of information in response to an operation received via the input receiving section 13. For example, the reception section 161 receives information indicating the target antenna size in response to the operation.

The acquisition section 162 acquires frequency spectrum information indicating the frequency spectrum. For example, the acquisition section 162 acquires frequency spectrum information stored in the storage section 12 from the storage section 12. Moreover, the acquisition section 162, for example, acquires frequency spectrum information from another device via a network.

The calculation section 163 performs various types of calculations in the information processing device 1. For example, the calculation section 163 calculates a product of the target antenna size indicated in the information received by the reception section 161 and a predetermined percentage of 30% or less, as the frequency interval.

The smoothing section 164 performs a smoothing process on the frequency spectrum.

The output section 165 outputs various types of information. For example, the output section 165 outputs various types of information to another device. Moreover, the output section 165 generates an image including the various types of information and causes the display section 15 to display the generated image.

The removal section 166 removes some of frequencies included in the frequency spectrum as removal target frequencies from the frequency spectrum.

<Process in which Information Processing Device Calculates Frequency Intervals>

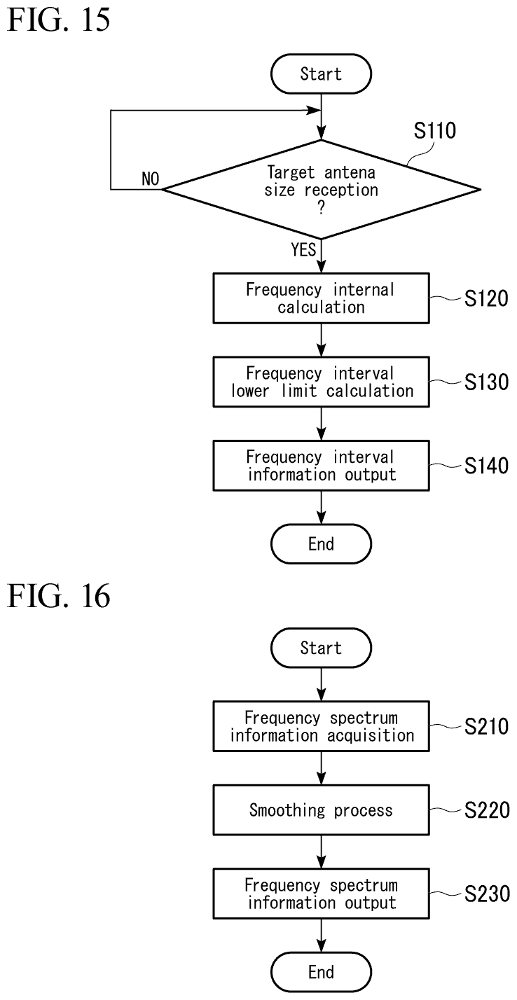

Hereinafter, a process in which the information processing device 1 calculates frequency intervals will be described with reference to FIG. 15. FIG. 15 is a flowchart showing an example of a flow of a process in which the information processing device 1 calculates frequency intervals. Hereinafter, as an example, a case where the information processing device 1 receives a first start operation for causing the information processing device 1 to start the process at a timing before the processing of step S110 shown in FIG. 15 is performed will be described. Also, hereinafter, as an example, a case where percentage information indicating a predetermined percentage of 30% or less is stored in advance in the storage section 12 will be described. Here, the percentage information may be any information as long as it indicates a percentage of 30% or less. Also, hereinafter, as an example, a case where frequency spectrum information X indicating the frequency spectrum of the transmission characteristics between the transmitting antenna 22 and the receiving antenna 23 in the reverberation chamber 2 in a state in which the test object TM is not arranged at that timing is stored in advance in the storage section 12 will be described. In addition, the frequency spectrum indicated in the frequency spectrum information X is a frequency spectrum that is often measured during calibration of the reverberation chamber 2. Therefore, in many cases, after the calibration is completed, it is unnecessary to measure the frequency spectrum of the transmission characteristics again so that the frequency spectrum indicated in the frequency spectrum information X is obtained.

After the first start operation is received, the reception section 161 waits for the target antenna size to be received via the input receiving section 13 (step S110).

When it is determined that the reception section 161 has received the target antenna size via the input receiving section 13 in step S110 (step S110-YES), the calculation section 163 decides the target antenna size to be used in step S120 as the received target antenna size. Also, the calculation section 163 calculates a product of a value obtained by dividing the speed of light by the decided target antenna size and a percentage indicated in the ratio information stored in the storage section 12 as a frequency interval (step S120).

Subsequently, the calculation section 163 calculates a lower limit of the frequency interval (step S130). Here, the processing of step S130 will be described. As the lower limit of the frequency interval, a frequency interval at which the fluctuation of the transmission characteristics becomes random is set so that the smoothing process can be effectively performed on the frequency spectrum of the transmission characteristics. In the reverberation chamber 2, various resonance modes are excited by stirring with the electromagnetic stirrer 24. On the other hand, within a resonance mode bandwidth, the transmission characteristics do not fluctuate greatly and the fluctuation of the transmission characteristics does not become random. Therefore, if the frequency interval of the transmission characteristics is set to an interval equal to or greater than the resonance mode bandwidth, a randomly fluctuating transmission characteristic can be obtained and the smoothing process can be effectively performed. Here, it is known that the resonance mode bandwidth of the reverberation chamber 2 is a value obtained by dividing the frequency by a Q value of the cavity resonator 21. On the other hand, because the wavelength is a value obtained by dividing the speed of light by the frequency in Eq. (4), the Q value is proportional to one over the cube of the frequency. Thereby, the resonance mode bandwidth is proportional to one over the square of the frequency. Considering the measurement time, the sampling interval of the frequency spectrum is more likely to shorten the time. Therefore, it is only necessary to decide the lower limit of the frequency interval according to the lower limit frequency of any frequency band so that the sampling interval is measured to be large. Thereby, the lower limit of the frequency interval is calculated on the basis of the volume of the reverberation chamber 2, the efficiency of the transmitting antenna 22, the efficiency of the receiving antenna 23, the lower limit of the frequency band of the frequency spectrum indicated in the frequency spectrum information X stored in the storage section 12, and the frequency spectrum. Specifically, in step S140, the calculation section 163 calculates the lower limit of the frequency interval on the basis of the following Eq. (5), where V denotes the volume, nix denotes efficiency of the transmitting antenna, ηᵣₓ denotes efficiency of the receiving antenna, f denotes a lower limit of the frequency band, R denotes the transmission characteristic indicated in the frequency spectrum when the frequency is f, c denotes the speed of light, and Δf denotes the lower limit of the frequency interval. In addition, when the efficiency of the transmitting antenna 22 and the efficiency of the receiving antenna 23 are unknown, 0.9 as the efficiency of a horn-type antenna and 0.75 as the efficiency of a log periodic antenna may be used as recommended in IEC 61000-4-21.

$$Δ f = \frac{{η}_{tx} {η}_{rx} {c}^{3}}{16 {π}^{2} {Vf}^{2} R} \qquad ( 5 )$$

In addition, in the process of the flowchart shown in FIG. 15, the target antenna size may be registered (stored) in advance in the information processing device 1. In this case, for example, the reception section 161 may receive the target antenna size by reading preregistered data, step S110 may be skipped, and step S120 and subsequent steps may be performed. Moreover, in the process of the flowchart shown in FIG. 15, the processing of step S130 may be omitted. Moreover, the information processing device 1 may be configured to cause the display section 15 to display warning information indicating a warning when the frequency interval calculated in step S120 is smaller than the lower limit of the frequency interval calculated in step S130. Moreover, the information processing device 1 may be configured to output a sound indicating the warning from a speaker in this case. In this case, the information processing device 1 includes the speaker.

After the processing of step S130 is performed, the output section 165 generates information including information indicating the frequency interval calculated by the calculation section 163 in step S120 and information indicating the lower limit of the frequency interval calculated by the calculation section 163 in step S130 as frequency interval information. Also, the output section 165 outputs the generated frequency interval information (step S140). Specifically, in step S140, the output section 165, for example, outputs the frequency interval information to another device. Moreover, for example, in step S140, the output section 165 generates an image including the frequency interval information and causes the display section 15 to display the generated image.

After the processing of step S140 is performed, the output section 165 ends the process of the flowchart shown in FIG. 15.

As described above, the information processing device 1 receives the target antenna size and calculates a product of the value obtained by dividing the speed of light by the received target antenna size and a predetermined percentage of 30% or less as the frequency interval. Thereby, the information processing device 1 can identify a sampling frequency that can accurately reduce the fluctuation of the transmission characteristics in a process of averaging the transmission characteristics between different sampling frequencies.

In addition, the information processing device 1 may be configured to receive percentage information along with the target antenna size information in the processing of step S110.

<Process in which Information Processing Device Performs Smoothing Process on Frequency Spectrum Detected Using Sampling Frequency Based on Frequency Interval>

Hereinafter, a process in which the information processing device 1 performs smoothing processing on the frequency spectrum detected using a sampling frequency based on the frequency interval calculated in the process of the flowchart shown in FIG. 15 will be described with reference to FIG. 16. FIG. 16 is a flowchart showing an example of a flow of a process in which the information processing device 1 performs a smoothing process on the frequency spectrum detected using a sampling frequency based on the frequency interval calculated in the process of the flowchart shown in FIG. 15. Hereinafter, as an example, a case where frequency spectrum information Y indicating a frequency spectrum detected using a sampling frequency based on the frequency interval calculated in the process of the flowchart shown in FIG. 15 is stored in advance in the storage section 12 at a timing before the processing of step S210 shown in FIG. 16 is performed will be described. In addition, the frequency spectrum may be detected by the information processing device 1 using the reverberation chamber 2 or may be detected by another device using the reverberation chamber 2. Moreover, hereinafter, as an example, a case where the information processing device 1 receives a second start operation for causing the information processing device 1 to start the process at the timing will be described.

After the second start operation is received, the acquisition section 162 reads and acquires the frequency spectrum information Y stored in the storage section 12 from the storage section 12 (step S210).

Subsequently, the smoothing section 164 performs a smoothing process on the frequency spectrum indicated in the frequency spectrum information Y acquired by the acquisition section 162 in step S210 (step S220). In addition, the smoothing process may be the moving average process described above, a time gate process, or another smoothing process.

Subsequently, the output section 165 outputs frequency spectrum information Y indicating the frequency spectrum after the smoothing process is performed by the smoothing section 164 in step S220 (step S230). Specifically, in step S230, the output section 165, for example, outputs the frequency spectrum information Y to another device. Moreover, in step S230, the output section 165 generates an image including the frequency spectrum information Y and causes the display section 15 to display the generated image.

After the processing of step S230 is performed, the output section 165 ends the process of the flowchart shown in FIG. 16.

As described above, the information processing device 1 acquires the frequency spectrum information Y, performs a smoothing process on the frequency spectrum indicated in the acquired frequency spectrum information Y, and outputs the frequency spectrum information Y indicating the frequency spectrum after the smoothing process. Thereby, the information processing device 1 can provide a frequency spectrum with highly accurate transmission characteristics.

<Process in which information processing device performs smoothing process on frequency spectrum detected using sampling frequency varying continuously in predetermined frequency band>

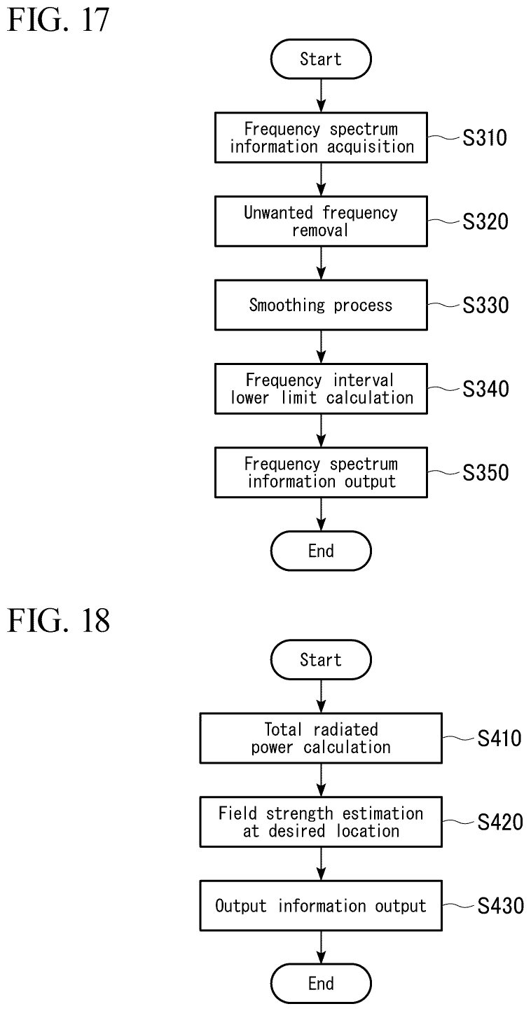

Hereinafter, a process in which the information processing device 1 performs a smoothing process on a frequency spectrum detected using a sampling frequency varying continuously in a predetermined frequency band will be described with reference to FIG. 17. FIG. 17 is a flowchart showing an example of a flow of the process in which the information processing device 1 performs the smoothing process on the frequency spectrum detected using the sampling frequency varying continuously in the predetermined frequency band. Hereinafter, as an example, a case where frequency spectrum information Z indicating a frequency spectrum of a transmission characteristic detected while a sampling frequency varying continuously in a predetermined frequency band is stored in the storage section 12 at a timing before the processing of step S310 shown in FIG. 17 is performed will be described. In addition, the frequency spectrum may be detected by the information processing device 1 using the reverberation chamber 2 or may be detected by another device using the reverberation chamber 2. Moreover, hereinafter, as an example, a case where frequency interval information indicating the frequency interval calculated in the process of the flowchart shown in FIG. 15 is stored in the storage section 12 at that timing will be described. Moreover, hereinafter, as an example, a case where the information processing device 1 receives a third start operation for causing the information processing device 1 to start the process at that timing will be described.

After the third start operation is received, the acquisition section 162 reads and acquires the frequency spectrum information Z stored in the storage section 12 from the storage section 12 (step S310).

Subsequently, the removal section 166 identifies a sampling frequency based on the frequency interval indicated in the frequency interval information stored in the storage section 12, designates a frequency other than the identified sampling frequency as a removal target frequency, and removes the removal target frequency from the frequency spectrum indicated in the frequency spectrum information Z acquired by the acquisition section 162 in step S310 (step S320). Thereby, the information processing device 1 can obtain a frequency spectrum similar to the frequency spectrum indicated in the frequency spectrum information Y acquired by the acquisition section 162 in step S210 shown in FIG. 16. In FIG. 17, the processing of step S320 is indicated by “unnecessary frequency removal.” In addition, the method for removing the removal target frequency from the frequency spectrum may be a known method or a method to be developed in the future.

Subsequently, the smoothing section 164 performs a smoothing process on the frequency spectrum after the frequency is removed by the removal section 166 in step S320 (step S330). The processing of step S330 is similar to the processing of step S220 shown in FIG. 17. Therefore, detailed description of the processing of step S330 will be omitted here.

Subsequently, the calculation section 163 calculates a lower limit of the frequency interval suitable for the frequency spectrum indicated in the frequency spectrum information Z acquired by the acquisition section 162 in step S310 (step S340). The lower limit of the frequency interval is calculated on the basis of the volume of the reverberation chamber, the efficiency of the transmitting antenna 22, the efficiency of the receiving antenna 23, the lower limit of the frequency band of the frequency spectrum, and the frequency spectrum. Specifically, in step S340, the calculation section 163 calculates the lower limit of the frequency interval on the basis of the following Eq. (6) where V denotes the volume, nix denotes efficiency of the transmitting antenna, ηᵣₓ denotes efficiency of the receiving antenna, f denotes a lower limit of the frequency band, R_{L} denotes the transmission characteristic indicated in the frequency spectrum when the frequency is f, c denotes the speed of light, and Δf denotes the lower limit of the frequency interval. In addition, when the efficiency of the transmitting antenna 22 and the efficiency of the receiving antenna 23 are unknown, 0.9 as the efficiency of a horn-type antenna and 0.75 as the efficiency of a log periodic antenna may be used as recommended in IEC 61000-4-21.

$$Δ f = \frac{{η}_{tx} {η}_{rx} {c}^{3}}{16 {π}^{2} {Vf}^{2} {R}_{L}} \qquad ( 6 )$$

In addition, the processing of step S340 may be omitted in the process of the flowchart shown in FIG. 17. Moreover, the information processing device 1 may be configured to cause the display section 15 to display warning information indicating a warning when the frequency interval indicated in the frequency interval information stored in the storage section 12 is smaller than the lower limit of the frequency interval calculated in step S340. Moreover, the information processing device 1 may be configured to output a sound indicating a warning from a speaker in this case. In this case, the information processing device 1 includes the speaker.

After the processing of step S340 is performed, the output section 165 outputs frequency spectrum information Z indicating the frequency spectrum after the smoothing process is performed by the smoothing section 164 in step S330 (step S350). At this time, the output section 165 also outputs information indicating the lower limit of the frequency interval calculated by the calculation section 163 in step S340 together with the frequency spectrum information Z. Specifically, in step S350, the output section 165, for example, outputs the frequency spectrum information Z and the information to another device. Moreover, in step S350, the output section 165 generates an image including the frequency spectrum information Z and the information and causes the display section 15 to display the generated image.

After the processing of step S350 is performed, the output section 165 ends the process of the flowchart shown in FIG. 17.

As described above, the information processing device 1 acquires the frequency spectrum information Z, sets a frequency other than the sampling frequency based on the frequency interval indicated in the frequency interval information stored in the storage section 12 as a removal target frequency, removes the removal target frequency from the frequency spectrum indicated in the frequency spectrum information Z, performs a smoothing process on the frequency spectrum after the removal target frequency is removed, and outputs the frequency spectrum information Z indicating the frequency spectrum after the smoothing process is performed. In this way, the information processing device 1 can generate a frequency spectrum with a more accurate transmission characteristic using a frequency spectrum with a transmission characteristic that has already been acquired, and provide the generated frequency spectrum.

<Process in which information processing device calculates total radiated power radiated as electromagnetic waves from test object and estimates electric field strength at desired location away from test object>

Hereinafter, a process in which the information processing device 1 calculates total radiated power radiated as electromagnetic waves from the test object TM and estimates electric field strength at a desired location away from the test object TM will be described with reference to FIG. 18. FIG. 18 is a flowchart showing an example of a flow of a process in which the information processing device 1 calculates the total radiated power radiated as the electromagnetic waves from the test object TM and estimates the electric field strength at a desired location away from the test object TM. Hereinafter, as an example, a case where, at a timing before the processing of step S410 shown in FIG. 18 is performed, target received power information indicating the measured target received power, target received power frequency information indicating a frequency of the target received power, maximum directivity information indicating the maximum directivity of the test object TM, frequency spectrum information W output in the process of the flowchart shown in FIG. 16 or FIG. 17, and transmitting antenna efficiency information indicating the efficiency of the transmitting antenna 22 are stored in the storage section 12 will be described. Moreover, hereinafter, as an example, a case where, at that timing, distance information indicating a distance from the test object TM to a location desired by the user among locations away from the test object TM is stored in the storage section 12 will be described. Moreover, hereinafter, as an example, a case where, at that timing, characteristic impedance information indicating the characteristic impedance of free space is stored in the storage section 12 will be described. Moreover, hereinafter, as an example, a case where the information processing device 1 receives a fourth start operation for causing the information processing device 1 to start the process at the timing will be described.

After a fourth operation is received, the calculation section 163 reads each item of the target received power information, the target received power frequency information, the frequency spectrum information W, and the transmitting antenna efficiency information stored in the storage section 12 from the storage section 12. Also, the calculation section 163 calculates the total radiated power radiated as electromagnetic waves from the test object TM on the basis of the target received power indicated in the target received power information, the frequency indicated in the target received power frequency information, the frequency spectrum indicated in the frequency spectrum information W, the efficiency indicated in the transmitting antenna efficiency information, and the above Eq. (2) (step S410). Specifically, in step S410, the calculation section 163 calculates the total radiated power on the basis of the target received power, the transmission characteristic indicated in the frequency spectrum at the frequency, the efficiency, and Eq. (2). In addition, when the efficiency of the transmitting antenna 22 and the efficiency of the receiving antenna 23 are unknown, 0.9 as the efficiency of a horn-type antenna and 0.75 as the efficiency of a log periodic antenna may be used as recommended in IEC 61000-4-21.

Subsequently, the calculation section 163 reads each item of the distance information, the characteristic impedance information, and the maximum directivity information stored in the storage section 12 from the storage section 12. Also, the calculation section 163 estimates the strength of the electric field generated by the electromagnetic waves radiated from the test object TM to a location that is the distance away from the test object TM, on the basis of the distance indicated in the distance information, the characteristic impedance indicated in the characteristic impedance information, the total radiated power calculated in step S410, the maximum directivity indicated in the maximum directivity information, and the above Eq. (3) (step S420).

Subsequently, the output section 165 generates information including information indicating the total radiated power calculated by the calculation section 163 in step S410 and information indicating the electric field strength calculated by the calculation section 163 in step S420 as output information. Also, the output section 165 outputs the generated output information (step S430). Specifically, in step S430, the output section 165, for example, outputs the output information to another device. Also, in step S430, the output section 165 generates an image including the output information and causes the display section 15 to display the generated image.

After the processing of step S430 is performed, the output section 165 ends the process of the flowchart shown in FIG. 18.

As described above, the information processing device 1 calculates the total radiated power radiated by the test object TM on the basis of the target received power output from the receiving antenna 23 and the frequency spectrum information W. Moreover, the information processing device 1 estimates the electric field strength at a location that is a predetermined distance away from the test object TM on the basis of the calculated total radiated power. Thereby, the information processing device 1 can perform the radiated emission test with high accuracy while shortening the time required for the radiated emission test using the reverberation chamber 2.

In addition, the reverberation chamber 2 described above may be configured to include an electric field sensor instead of the receiving antenna 23. In this case, the electric field strength detected by the electric field sensor can be converted into the received power estimated to be received by the receiving antenna 23 on the basis of the following Eq. (7). Here, Prec denotes the received power. E denotes the electric field strength.

$${P}_{rec} = \frac{{λ}^{2} {E}^{2}}{320 {π}^{2}} \qquad ( 7 )$$

In addition, the above Eq. (7) is derived in a state in which the efficiency of the receiving antenna 23 is 1. Therefore, the calculation of the received power based on Eq. (7) does not affect the calculation of the frequency interval described above.

Moreover, the matters described above may be combined in any way.

### Appendixes

[1] A program for causing a computer to execute: a decision step of deciding a larger antenna size between antenna sizes of a transmitting antenna provided within a reverberation chamber in which a test object is arranged and a receiving antenna provided within the reverberation chamber as a target antenna size; and a first calculation step of calculating a product of a value obtained by dividing a speed of light by the target antenna size decided in the decision step and a predetermined percentage of 30% or less as an interval between sampling frequencies for detecting a first frequency spectrum that is a frequency spectrum of a first transmission characteristic that is a transmission characteristic between the transmitting antenna and the receiving antenna.

[2] The program according to [1], wherein the computer executes a reception step of receiving the percentage, and wherein the first calculation step includes calculating the product of the value obtained by dividing the speed of light by the target antenna size decided in the decision step and the percentage received in the reception step as the interval.

[3] The program according to [1] or [2], wherein the computer executes a first acquisition step of acquiring first frequency spectrum information indicating the first frequency spectrum detected using the sampling frequency based on the interval calculated in the first calculation step; a first smoothing step of performing a process of smoothing the first frequency spectrum indicated in the first frequency spectrum information acquired in the first acquisition step; and an output step of outputting the first frequency spectrum information indicating the first frequency spectrum after the smoothing process performed in the first smoothing step.

[4] The program according to any one of [1] to [3], wherein the computer executes a third calculating step of calculating a lower limit of the interval on the basis of a volume of the reverberation chamber, a lower limit of a frequency band of the first frequency spectrum, and the second frequency spectrum, and wherein the second frequency spectrum is a frequency spectrum of a second transmission characteristic that is a transmission characteristic between the transmitting antenna and the receiving antenna in the reverberation chamber of a state in which the test object is not arranged.

[5] The program according to [4], wherein the third calculation step includes calculating the lower limit of the interval on the basis of the following Eq. (8)

$$Δ f = \frac{{η}_{tx} {η}_{rx} {c}^{3}}{16 {π}^{2} {Vf}^{2} R} , \qquad ( 8 )$$

where V denotes the volume, nix denotes efficiency of the transmitting antenna, ηᵣₓ denotes efficiency of the receiving antenna, f denotes a lower limit of the frequency band, R denotes the second transmission characteristic indicated in the second frequency spectrum when the frequency is f, c denotes the speed of light, and Δf denotes the lower limit of the interval.

[6] The program according to any one of [1] to [5], wherein the computer executes a second acquisition step of acquiring first frequency spectrum information indicating the first frequency spectrum detected using a sampling frequency continuously varying in a predetermined frequency band; a removal step of designating a frequency other than a sampling frequency based on the interval calculated in the first calculation step as a removal target frequency and removing the removal target frequency from the first frequency spectrum indicated in the first frequency spectrum information acquired in the second acquisition step; a second smoothing step of performing a process of smoothing the first frequency spectrum after the removal target frequency is removed in the removal step; and an output step of outputting the first frequency spectrum information indicating the first frequency spectrum after the smoothing process performed in the second smoothing step.

[7] The program according to [6], wherein the computer executes a fourth calculation step of calculating a lower limit of the interval on the basis of a volume of the reverberation chamber, a lower limit of the frequency band, and the first frequency spectrum indicated in the first frequency spectrum information acquired in the second acquisition step.

[8] The program according to [7], wherein the fourth calculation step calculates the lower limit of the interval on the basis of the following Eq. (9)

$$Δ f = \frac{{η}_{tx} {η}_{rx} {c}^{3}}{16 {π}^{2} {Vf}^{2} {R}_{L}} , \qquad ( 9 )$$

where V denotes the volume, ηₜₓ denotes efficiency of the transmitting antenna, ηᵣₓ denotes efficiency of the receiving antenna, f denotes a lower limit of the frequency band, R_{L} denotes the first transmission characteristic indicated in the first frequency spectrum when the frequency is f, c denotes the speed of light, and Δf denotes the lower limit of the interval.

[9] The program according to [3] or [6], wherein the computer executes a fifth calculation step of calculating total radiated power radiated as electromagnetic waves by the test object on the basis of target received power output from the receiving antenna that receives the electromagnetic waves radiated from the test object within the reverberation chamber in a state in which radiation of electromagnetic waves from the transmitting antenna is stopped and the first frequency spectrum information output in the output step.

The program according to [9], wherein the computer executes an estimation step of estimating strength of an electric field at a location that is a previously received distance away from the test object on the basis of the total radiated power calculated in the fifth calculation step.

A calculation method including: deciding a larger antenna size between antenna sizes of a transmitting antenna provided within a reverberation chamber in which a test object is arranged and a receiving antenna provided within the reverberation chamber as a target antenna size; and calculating a product of a value obtained by dividing a speed of light by the decided target antenna size and a predetermined percentage of 30% or less as an interval between sampling frequencies for detecting a first frequency spectrum that is a frequency spectrum of a first transmission characteristic that is a transmission characteristic between the transmitting antenna and the receiving antenna.

An information processing device including: a communication section communicatively connected to a transmitting antenna and a receiving antenna provided within a reverberation chamber in which a test object is arranged; and a control section configured to execute a decision process of deciding a larger antenna size between antenna sizes of a transmitting antenna and a receiving antenna as a target antenna size and a calculation process of calculating a product of a value obtained by dividing a speed of light by the target antenna size decided in the decision process and a predetermined percentage of 30% or less as an interval between sampling frequencies for detecting a first frequency spectrum that is a frequency spectrum of a first transmission characteristic that is a transmission characteristic between the transmitting antenna and the receiving antenna.

Although the embodiment of the present disclosure has been described in detail above with reference to the drawings, the specific configuration is not limited to the present embodiment and may be modified, substituted, deleted, and the like without departing from the spirit and scope of the present disclosure.

Also, a program for implementing a function of any constituent section in a device (e.g., the information processing device 1 or the like) may be recorded on a computer-readable recording medium and a computer system may be allowed to read and execute the program recorded on the recording medium. Also, it is assumed that the “computer system” used here includes an operating system (OS) or hardware such as peripheral devices. Moreover, the “computer-readable recording medium” refers to a flexible disk, a magneto-optical disc, a read-only memory (ROM), a portable medium such as a compact disc-ROM (CD-ROM), or a storage device such as a hard disk embedded in the computer system. Furthermore, the “computer-readable recording medium” is assumed to include a computer-readable recording medium for holding the program for a given period of time as in a volatile memory (for example, a random-access memory (RAM)) inside the computer system including a server and a client when the program is transmitted via a network such as the Internet or a communication circuit such as a telephone circuit.

Also, the above-described program may be transmitted from a computer system storing the program in a storage device or the like via a transmission medium or transmitted to another computer system through transmission waves in a transmission medium. Here, the “transmission medium” for transmitting the program refers to a medium having a function of transmitting information as in a network (a communication network) such as the Internet or a communication circuit (a communication line) such as a telephone circuit.

Also, the above-described program may be a program for implementing some of the above-described functions. Furthermore, the above-described program may be a program capable of implementing the above-described function in combination with a program already recorded on the computer system, i.e., a so-called differential file (differential program).

### DESCRIPTION OF REFERENCES

1 Information processing device
2 Reverberation chamber
11 Processor
12 Storage section
13 Input reception section
14 Communication section
15 Display section
16 Control section
21 Cavity resonator
22 Transmitting antenna
23 Receiving antenna
24 Electromagnetic stirrer
161 Reception section
162 Acquisition section
163 Calculation section
164 Smoothing section
165 Output section
166 Removal section
TM Test object

1. A program for causing a computer to execute:
a decision step of deciding a larger antenna size between antenna sizes of a transmitting antenna provided within a reverberation chamber in which a test object is arranged and a receiving antenna provided within the reverberation chamber as a target antenna size; and
a first calculation step of calculating a product of a value obtained by dividing a speed of light by the target antenna size decided in the decision step and a predetermined percentage of 30% or less as an interval between sampling frequencies for detecting a first frequency spectrum that is a frequency spectrum of a first transmission characteristic that is a transmission characteristic between the transmitting antenna and the receiving antenna.

2. The program according to claim 1,
wherein the computer executes a reception step of receiving the percentage, and
wherein the first calculation step includes calculating the product of the value obtained by dividing the speed of light by the target antenna size decided in the decision step and the percentage received in the reception step as the interval.

3. The program according to claim 1, wherein the computer executes
a first acquisition step of acquiring first frequency spectrum information indicating the first frequency spectrum detected using the sampling frequency based on the interval calculated in the first calculation step;
a first smoothing step of performing a process of smoothing the first frequency spectrum indicated in the first frequency spectrum information acquired in the first acquisition step; and
an output step of outputting the first frequency spectrum information indicating the first frequency spectrum after the smoothing process performed in the first smoothing step.

4. The program according to claim 1,
wherein the computer executes a third calculating step of calculating a lower limit of the interval on the basis of a volume of the reverberation chamber, a lower limit of a frequency band of the first frequency spectrum, and the second frequency spectrum, and
wherein the second frequency spectrum is a frequency spectrum of a second transmission characteristic that is a transmission characteristic between the transmitting antenna and the receiving antenna in the reverberation chamber of a state in which the test object is not arranged.

5. The program according to claim 4, wherein the third calculation step includes calculating the lower limit of the interval on the basis of
$$Δ f = \frac{{η}_{tx} {η}_{rx} {c}^{3}}{16 {π}^{2} {Vf}^{2} R} , \qquad ( 1 )$$
where V denotes the volume, nix denotes efficiency of the transmitting antenna, ηᵣₓ denotes efficiency of the receiving antenna, f denotes a lower limit of the frequency band, R denotes the second transmission characteristic indicated in the second frequency spectrum when the frequency is f, c denotes the speed of light, and Δf denotes the lower limit of the interval.

6. The program according to claim 1, wherein the computer executes
a second acquisition step of acquiring first frequency spectrum information indicating the first frequency spectrum detected using a sampling frequency continuously varying in a predetermined frequency band;
a removal step of designating a frequency other than a sampling frequency based on the interval calculated in the first calculation step as a removal target frequency and removing the removal target frequency from the first frequency spectrum indicated in the first frequency spectrum information acquired in the second acquisition step;
a second smoothing step of performing a process of smoothing the first frequency spectrum after the removal target frequency is removed in the removal step; and
an output step of outputting the first frequency spectrum information indicating the first frequency spectrum after the smoothing process performed in the second smoothing step.

7. The program according to claim 6, wherein the computer executes a fourth calculation step of calculating a lower limit of the interval on the basis of a volume of the reverberation chamber, a lower limit of the frequency band, and the first frequency spectrum indicated in the first frequency spectrum information acquired in the second acquisition step.

8. The program according to claim 7, wherein the fourth calculation step calculates the lower limit of the interval on the basis of
$$Δ f = \frac{{η}_{tx} {η}_{rx} {c}^{3}}{16 {π}^{2} {Vf}^{2} {R}_{L}} , \qquad ( 2 )$$
where V denotes the volume, nix denotes efficiency of the transmitting antenna, ηᵣₓ denotes efficiency of the receiving antenna, f denotes a lower limit of the frequency band, R_{L} denotes the first transmission characteristic indicated in the first frequency spectrum when the frequency is f, c denotes the speed of light, and Δf denotes the lower limit of the interval.

9. The program according to claim 3, wherein the computer executes a fifth calculation step of calculating total radiated power radiated as electromagnetic waves by the test object on the basis of target received power output from the receiving antenna that receives the electromagnetic waves radiated from the test object within the reverberation chamber in a state in which radiation of electromagnetic waves from the transmitting antenna is stopped and the first frequency spectrum information output in the output step.

10. The program according to claim 6, wherein the computer executes a fifth calculation step of calculating total radiated power radiated as electromagnetic waves by the test object on the basis of target received power output from the receiving antenna that receives the electromagnetic waves radiated from the test object within the reverberation chamber in a state in which radiation of electromagnetic waves from the transmitting antenna is stopped and the first frequency spectrum information output in the output step.

11. The program according to claim 9, wherein the computer executes an estimation step of estimating strength of an electric field at a location that is a previously received distance away from the test object on the basis of the total radiated power calculated in the fifth calculation step.

12. The program according to claim 10, wherein the computer executes an estimation step of estimating strength of an electric field at a location that is a previously received distance away from the test object on the basis of the total radiated power calculated in the fifth calculation step.

13. A calculation method comprising:
deciding a larger antenna size between antenna sizes of a transmitting antenna provided within a reverberation chamber in which a test object is arranged and a receiving antenna provided within the reverberation chamber as a target antenna size; and
calculating a product of a value obtained by dividing a speed of light by the decided target antenna size and a predetermined percentage of 30% or less as an interval between sampling frequencies for detecting a first frequency spectrum that is a frequency spectrum of a first transmission characteristic that is a transmission characteristic between the transmitting antenna and the receiving antenna.

14. An information processing device comprising:
a communication section communicatively connected to a transmitting antenna and a receiving antenna provided within a reverberation chamber in which a test object is arranged; and
a control section configured to execute a decision process of deciding a larger antenna size between antenna sizes of a transmitting antenna and a receiving antenna as a target antenna size and a calculation process of calculating a product of a value obtained by dividing a speed of light by the target antenna size decided in the decision process and a predetermined percentage of 30% or less as an interval between sampling frequencies for detecting a first frequency spectrum that is a frequency spectrum of a first transmission characteristic that is a transmission characteristic between the transmitting antenna and the receiving antenna.

15. A non-transitory storage medium storing the program according to claim 1.
